(19) United States
(12) Patent Application Publication
(10) Pub. No.: US 2025/0124377 A1
(43) Pub. Date: Apr. 17, 2025

(54) Shiny Based System for Determining Inventory Parameters

(71) Applicant: West Virginia University Board of Governors on Behalf of West Virginia University, Morgantown, WV (US)

(72) Inventors: Bradley Price, Morgantown, WV (US); John Saldanha, Morgantown, WV (US)

(21) Appl. No.: 18/416,661

(22) Filed: Jan. 18, 2024

Related U.S. Application Data
(60) Provisional application No. 63/439,853, filed on Jan. 18, 2023.

(51) Int. Cl. G06Q 10/0631

(52) U.S. Cl. CPC G06Q 10/06315

(57) ABSTRACT

Disclosed are various approaches for inventory management using a bootstrap approach. A computing device can receive at least a first input dataset associated with at least a lead time of a first raw material. Next, the computing device can receive at least a second input dataset associated with a demand for a plurality of final products, the plurality of final products corresponding to the first raw material. The computing device can perform a non-parametric bootstrap using at least the first input dataset and at least the second input dataset to generate a probability density function of lead time demand for the first raw material. The computing device can determine a safety stock estimate for the first raw material based at least in part on the probability density function of lead time demand.

### CROSS-REFERENCE TO RELATED APPLICATION

This application claims priority to and the benefit of co-pending U.S. provisional application entitled “A Shiny Based System for Determining Inventory Parameters” having Ser. No. 63/439,853, filed on Jan. 18, 2023, which is hereby incorporated by reference in its entirety.

### BACKGROUND

Setting appropriate safety stock levels is an important decision for firms in many industries. For several years, global sourcing has continued to grow leaving firms to face long and variable lead times. Furthermore, lead time demands (LTD) that are highly variable can persist with domestic suppliers due to multiple sources of uncertainty, such as unpredictable manufacturing environments, potential disruptions to transportation and distribution infrastructure, and potentially permanent shifts in consumer demand patterns. In practice, final product demand is highly volatile and has high incidence of zero demand. The textbook approach to setting safety stocks assumes that LTD follows a known distribution (e.g., normal), but it is well documented that LTD can be long, highly variable, skewed or multi-modal. Costs of both inventory storage and service failures can be high, making the safety stock decision critical. Existing bootstrap approaches for inventory management either operate directly on observed LTD or assume deterministic lead times, permitting direct application of the bootstrap approach for univariate quantile estimation. Given these characteristics, following a standard approach for setting component input safety stocks directly from aggregate demand and assuming that lead time demand follows a normal distribution, works poorly.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is an example of estimated lead time demand distribution for two raw materials according to various embodiments of the present disclosure. Further detail and discussion of FIG. 1 can be found in Appendix 1.

FIG. 2 is an example of cumulative distribution functions (CDFs) comparing the true left skew bimodal distribution with μ_{L}=25 and CV_{L}=0.34 to show that the bimodal CDF may coincide with that of the normal and gamma CDFs to yield similar or the same safety stocks, according to various embodiments of the present disclosure. Further detail and discussion of FIG. 2 can be found in Appendix 1.

FIG. 3 is an example of the mean absolute percentage error (MAPE) of a bootstrap, gamma and baseline from the true safety stock (i.e., benchmark), according to various embodiments of the present disclosure. Further detail and discussion of FIG. 3 can be found in Appendix 1.

FIG. 4 is an example of the relative difference of the bootstrap and gamma from the benchmark, according to various embodiments of the present disclosure. Further detail and discussion of FIG. 4 can be found in Appendix 1.

FIG. 5 is an example of an online application developed to calculate the bootstrap estimate of safety stock and bootstrap safety stock confidence intervals for their raw materials, according to various embodiments of the present disclosure. Further detail and discussion of FIG. 5 can be found in Appendix 1.

FIG. 6 is an example of plots of the benchmark and gamma LTD cumulative distribution function, according to various embodiments of the present disclosure. Further detail and discussion of FIG. 6 can be found in Appendix 1.

FIGS. 7A-7C are examples of comparisons of the proposed bootstrap method using the compound distribution framework to a standard method for setting safety stock levels at varying sample sizes, according to various embodiments of the present disclosure. Further detail and discussion of FIGS. 7A-7C can be found in Appendix 1.

FIG. 8 is an example of a comparison of MAPE between four estimators on a bimodal distribution for the first distribution and component distributions of the bimodal lead time distributions used to generate the mixture of lead time demand, according to various embodiments of the present disclosure. Further detail and discussion of FIG. 8 can be found in Appendix 1.

FIG. 9 is an example of an average within replication MAPE difference between the proposed method and a standard method for 400 replications for the first distribution, according to various embodiments of the present disclosure. Further detail and discussion of FIG. 9 can be found in Appendix 1.

FIG. 10 is an example of a comparison of MAPE between four estimators on a bimodal distribution for the second distribution, according to various embodiments of the present disclosure. Further detail and discussion of FIG. 10 can be found in Appendix 1.

FIG. 11 is an example of an average within replication MAPE difference between the proposed method and a standard method for the second distribution, according to various embodiments of the present disclosure. Further detail and discussion of FIG. 11 can be found in Appendix 1.

FIG. 12 is an example of a comparison of MAPE between four estimators on a bimodal distribution for the third distribution, according to various embodiments of the present disclosure. Further detail and discussion of FIG. 12 can be found in Appendix 1.

FIG. 13 is an example of an Average within replication MAPE difference between the proposed method and a standard method for the third distribution, according to various embodiments of the present disclosure. Further detail and discussion of FIG. 13 can be found in Appendix 1.

FIG. 14 is an example of a comparison of MAPE between four estimators on a bimodal distribution for the fourth distribution, according to various embodiments of the present disclosure. Further detail and discussion of FIG. 14 can be found in Appendix 1.

FIG. 15 is an example of a comparison of an average within replication MAPE difference between the proposed method and a standard method for the fourth distribution, according to various embodiments of the present disclosure. Further detail and discussion of FIG. 15 can be found in Appendix 1.

FIG. 16 is an example of a best method for estimating safety stocks when LTD distribution is unimodal, according to various embodiments of the present disclosure. Further detail and discussion of FIG. 16 can be found in Appendix 1.

FIG. 17 is an example of a best method for estimating safety stocks when LTD distribution is bimodal, according to various embodiments of the present disclosure. Further detail and discussion of FIG. 17 can be found in Appendix 1.

FIGS. 18A-18C are examples of benchmark lead time demand distributions, according to various embodiments of the present disclosure. Further detail and discussion of FIGS. 18A-18C can be found in Appendix 1.

FIG. 19 is an example of a simulation output graph contrasting two stock keeping units (SKUs) (FIGS. 19A and B respectively) showing how, without accurate safety stock estimation and when faced with non-standard distributions, management may either carry too much stock (SKU 3) or loose sales with too little stock (SKU 17) as shown by the inventory position, reorder point, inventory balance on-hand and backorders, according to various embodiments of the present disclosure. Further detail and discussion of FIG. 19 can be found in Appendix 1.

FIGS. 20A-20C are examples of comparisons between sampling schemes used by univariate and multivariate bootstrap estimators, according to various embodiments of the present disclosure.

FIGS. 21A-21C are examples of estimated LTD probability density functions for three child components, according to various embodiments of the present disclosure. Examples include FIG. 21A 10 parent products for Component A, FIG. 21B 50 parent products for Component B, and FIG. 21C 187 parent products for Component C.

FIG. 22 is an example of a mean absolute percentage error for each of the four methods to estimate safety stock explored in the simulation, according to various embodiments of the present disclosure.

FIG. 23 is an example of a mean absolute percentage error for each of the four methods to estimate safety stock explored in the simulation, according to various embodiments of the present disclosure.

FIG. 24 is an example of an Amazon Web Services (AWS) application interface after completion of the safety stock calculation, according to various embodiments of the present disclosure.

FIGS. 25A-25B are examples of results of implementation of bootstrap methodology for 17 components, according to various embodiments of the present invention. FIG. 25A compares percentage change in actual safety-stock levels pre- and post-implementation. FIG. 25B compares percentage difference in safety stock values set by the legacy method and the bootstrap methods.

FIGS. 26A-26C are examples of comparisons of the bootstrap sampling distribution of the 0.95 quantile of non-parametric approaches for three components' parent products. Examples include components that are used in FIG. 26A 9 parent products, FIG. 26B 24 parent products, and FIG. 26C 26 parent products.

FIG. 27 is an example of a computing device, according to various embodiments of the present disclosure.

### DETAILED DESCRIPTION

Disclosed are various systems and methods for inventory management using a bootstrap approach. A bootstrap is a widely used statistical procedure which allows for estimation of the sampling distribution of a statistic using random sampling methods. Many important supply chain strategies such as postponed product differentiation and centralized storage rely on taking advantage of the reduction in variability that is obtained when multiple demands are aggregated together. Indeed, this concept, known as risk pooling, has been called the single most important concept in supply chain management. For the benefits of risk pooling to be realized, an accurate description of the aggregated demand is needed. This demand description-typically an estimated probability density function (pdf) of lead time demand (LTD)—is then used to inform some resource allocation decision such as the appropriate level of safety stock for a common component.

A decision maker has (at least) two choices in determining how to develop a description of demand to support a safety stock decision in a demand aggregation setting. First, one can either assume a distributional form (e.g., Normal) and estimate parameters, or adopt a non-parametric approach. Second, one can either operate directly on the aggregated demand data, or one can attempt to exploit information in the item-level demand that is being aggregated. A non-parametric, data-driven approach that leverages item-level demands is disclosed. This disclosure describes why such an approach might outperform both parametric approaches as well as non-parametric approaches that work directly on aggregated data. There are no existing non-parametric approaches that leverage item-level demand to provide accurate aggregated demand descriptions, this disclosure relates to the development of this approach, along with clear guidelines for how it can be implemented. The practical value of this approach is demonstrated by successful implementation with an example industry setting.

In an inventory system, with risk pooling or otherwise, the choice to eschew distributional assumptions and adopt a non-parametric approach depends on the validity of the distributional assumption. In many settings, typical compound distribution approaches presented in textbooks, can return severely flawed estimates in the presence of non-standard LTD distributions that result from non-standard lead-time and demand distributions. In a pooling setting, stochastic non-standard distributions of both component replenishment lead times and parent products' demand make it hard to estimate pooled safety stocks. (Final products are referred to as “parents” of a common component “child”). As described later, both lead times and finished product demands from the example industry setting exhibit strong, non-standard distributional shapes.

To illustrate the intuition of how item-level information may improve inventory estimates, below is a simple example of sampling with replacement from either the aggregated demand directly, or from the item-level demand and then constructing an aggregated demand distribution estimate. These approaches are termed univariate bootstrap (operate directly on the aggregate demand) or multivariate bootstrap (operate on the item-level demand). These approaches are applied to estimate the LTD distribution for a common component that supports n=10 parent products, lead time is deterministically one, and all demands are independent and standard Normal. With these choices, the true LTD distribution is Normal with mean zero and variance 10. A Monte-Carlo simulation is used where 75,000 random draws are independently sampled with replacement under the univariate and multivariate bootstrap sampling approach.

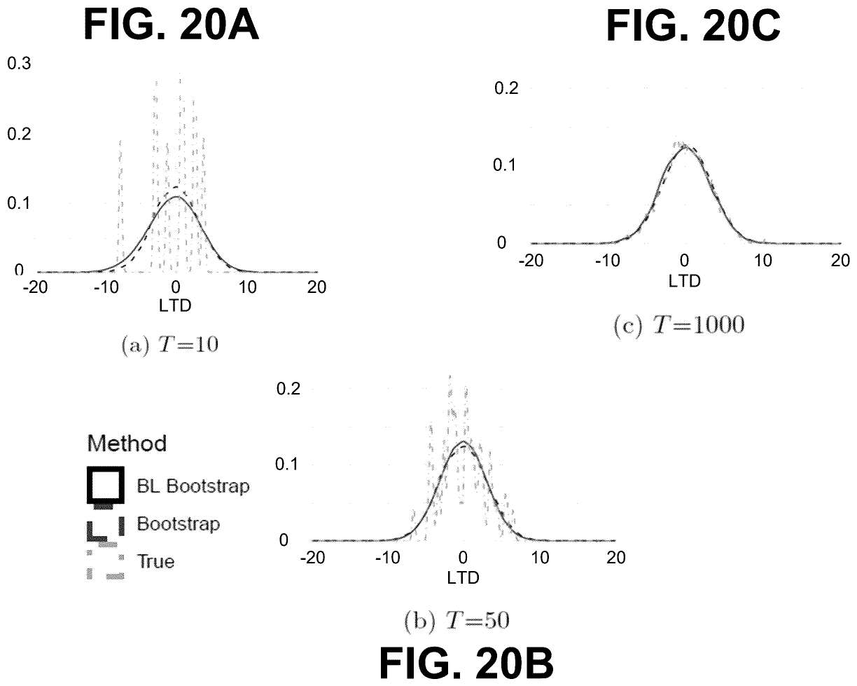

Densities obtained by the univariate and multivariate bootstrap approaches for different levels of demand history (T), along with the true densities, are shown in FIGS. 20A-20C. It is immediately apparent from FIGS. 20A-20C that when the sample size is small (e.g., T=10, FIG. 20A), the multivariate approach gives a more accurate approximation of the true density as compared to the univariate approach. This is due to the univariate approach having T possible demand values from which to draw (the total demand in each of T periods) while the multivariate approach has Tⁿ possible demand values since this approach permits combining item-level demands from different time periods. This advantage comes at the cost of ignoring potential contemporaneous correlation in parent product demand since the multivariate approach permits assembly of demand distributions that combine item-level demands from different time periods.

According to various examples, a bootstrap is used that leverages individual final product demands. Controlled numerical experiments were used to explore how the bootstrap approach compares to alternative approaches. The bootstrap approach was deployed on seventeen (17) input components. When available demand and lead-time data is limited and contemporaneous demand correlation is moderate, this approach of leveraging individual final product demands outperforms approaches that operate directly on aggregate demand.

In various examples, a multivariate central limit theorem was developed for the bootstrap mean and bootstrap quantile—components of the safety stock calculation—highlighting why the generalization of these bootstrap methods is critical for inventory management. These results provide a theoretical underpinning for the bootstrap estimator of safety stock and permit the construction of confidence intervals for safety stock estimates, allowing decision makers to understand the reliability with which the desired service level will be achieved.

Numerical experiments were conducted, providing insights on the behavior of the bootstrap for various LTD distributions, which the results demonstrate are critical when employing the bootstrap method.

According to various embodiments, the present disclosure relates to a bootstrap approach to set safety stocks for a child component related to multiple parent products in a way that leverages item-level (rather than aggregated) demand. This data-driven method estimates safety stocks directly from the child component's stochastic replenishment lead-time data and its multiple parent products' stochastic demand data.

### Industry Setting

### Production and Procurement Planning

Due to a variety of factors, long-term planning is not possible and campaign frequencies are managed short-term, anywhere from a 0-6 month period. Hence, while a four-month fence is used to freeze production, managers treat this more as, “a ‘slushy’ period due to the volatile demand in the industry and the need to be flexible” (email communication with procurement planning manager). Finished goods manufacturing campaigns are scheduled in a batch process to minimize changeover time and costs, depending upon customer demand, finished-goods shelf-life, and manufacturing efficiency. Consequently, in such a production environment driven by campaigns with large lot-sizes and volatile market demand, parent products can experience zero demand in multiple periods.

Planning for meeting parent products' customer demand is often decoupled from planning for maintaining child component inventories. Customer demand forecasts determine finished products' manufacturing campaigns that are made-to-stock while, component safety stocks are set independently. However, the reality is more complicated, due to the ‘slushy’ production planning period the system can operationally resemble an assemble-to-order system. Regardless, allowance is made for the statistical scale economies of aggregating component demand across multiple parent products' stochastic demand as, the allocation of components to individual parent products is effectively ‘postponed’ until a parent's production campaign is executed.

It is important to note that operations managers in some companies' production and procurement planning groups do not control or have input into, the creation of parent products' demand forecasts. Neither do these groups have any input into the product design nor have any control over component commonality decisions. This is the reality that the production and procurement planning groups face when setting inventory parameters, and it is a consistent practice across many organizations. Such organizational design can be observed in many other settings including in the consumer-packaged goods food industry, food scientists decide product ingredients and parent product form while sales and marketing, who typically have the organizational profit-and-loss responsibility, dictate sales strategies that drive production scheduling. Materials' management typically entails ensuring a sufficient supply of components for production. Similar practices can be seen in large firms of other industries that require a high specialization in product design such as, automotive, pharmaceuticals and electronic component manufacturing industries. In addition, as is common in many industries, the sales team often provides forecasts to the production and procurement planning groups whose analysts take into account the parents' desired service level when setting the child components' service level.

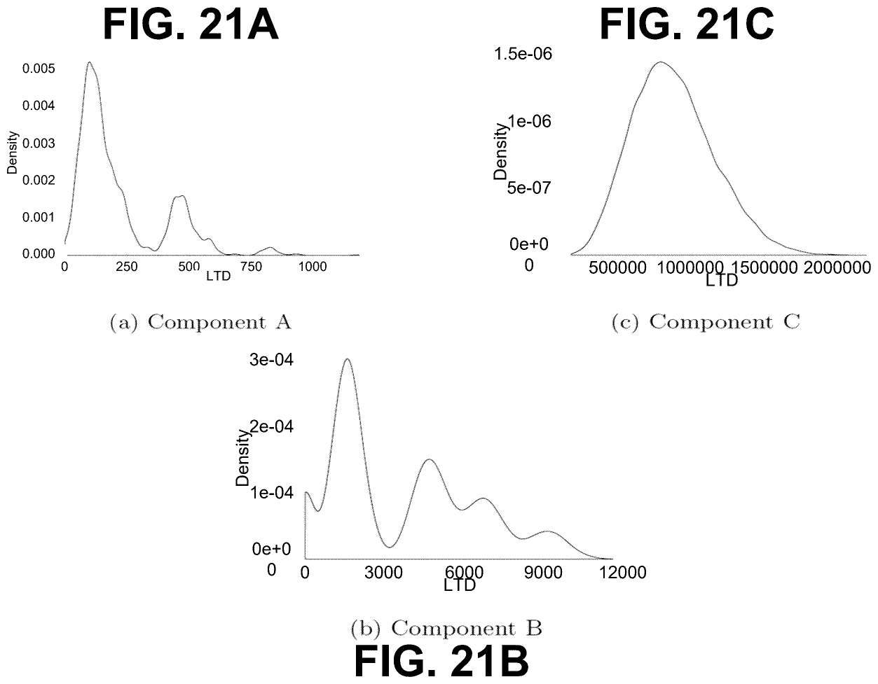

In general, all components discussed herein can be classified into two types. The first type has a one-to-one relationship with a parent product in the bill of materials (BOM) file, while the second type has a one-to-many relationship. This disclosure focuses on the second type that includes items sourced from international or domestic suppliers with long or short lead-times, respectively. In addition, it was determined that most parent product demand and child components' lead times displayed skewed, multi-modal, non-standard distributions that often result in non-standard LTD distributions. In FIGS. 21A-21C, three of the manufacturer's component SKUs' estimated LTD density functions ordered from A-C by the number of parent products. To estimate these densities, a Monte-Carlo simulation was run with replacement and generated one million empirical mixtures of LTD.

The bell-shaped LTD distribution of Component C in FIG. 21C indicates it is a good candidate for inventory policy estimation by textbook methods such as using approximations for component safety stocks aggregated across multiple parents provided by the Normal or Gamma distributions. However, a bootstrap approach is more appropriate for the non-standard LTD distributions displayed by Component A and B in FIGS. 21A and 21B, respectively.

### Setting Safety Stocks: Legacy Approach

A continuous review inventory control policy with a cycle service level (CSL) criterion is used to replenish child components pulled by manufacturing; managers vary CSL targets by criticality of component supply. As part of the planning process, analysts in the procurement planning group are required to estimate safety stocks for all components quarterly. This data is entered into the MRP module of the enterprise resource planning (ERP) system. The ERP system then factors in the component's supplier lead time and uses the BOM to convert the periodic demand of the parent products to set a corresponding reorder point (ROP) for the respective child component.

Due to the volatile lead time and demand, and in the interest of prioritizing in-stock availability of critical components, many companies employ a legacy approach for setting child component safety stocks. Other approaches factor in numerous manual inputs for each child component such as sourcing decisions, supplier reliability, supplier quality, campaign frequency, supplier lead time, finished-product failure-to-supply penalty, finished-product gross-margins, etc. These manual inputs are subjectively scored and weighted by senior management to suggest a specific months-on-hand quantity of an annual usage forecast dependent on parent product demand, which are then entered into the MRP module as a safety stock.

While the other approach prioritized critical components to ensure in-stock availability, it was subjective, manual, and error prone. On the one hand, it leads to large inventories that not only incur high inventory costs but also, take up valuable warehouse space and lead to expensive component write-offs due to high incidence of obsolescence. On the other hand, production experiences frequent stockouts for some components, which delays customer fulfillment that risks incurring expensive failure-to-supply penalties. The subjective process is also lengthy and tedious, requiring two analysts spend on average twenty (20) hours each, every quarter manually evaluating subjective scores and entering data for hundreds of components. Thus, there is motivation to develop and implement a non-parametric approach to simultaneously set safety stocks and ROPs for the entire portfolio of components with one-to-many parent relationships.

### Problem Motivation

Finished goods demand in many industries is volatile. Inspection of the demand and forecasting data confirmed that the mean absolute percentage errors (MAPE) were over 50% and forecast errors were non-Normal. The demand of several parent products is zero in many time periods. The occurrence of parent products' zero demands is not systematic, and relates to unforeseen changes in sales strategies, customer demands and consequently, production campaign schedules. Using data given to develop a cloud-based application for deployment it was found that 66% of the parent products had an occurrence of zero-demand periods. In Table 1, shown is an example of a child component's nine parent products with zero demands that result in the pseudo-correlation (as high a 0.9) seen in Table 2, due to the high frequency of zero demands. There are many additional examples of components with the patterns of zero demands randomly occurring across all parent products including across fast- and slow-moving parents.

TABLE 1
Example of demand data for a single child component with 9 parent products.

| Finished | | | | | | | | | | | | |
|---|---|---|---|---|---|---|---|---|---|---|---|---|
| Good | Time 1 | Time 2 | Time 3 | Time 4 | Time 5 | Time 6 | Time 7 | Time 8 | Time 9 | Time 10 | Time 11 | Time 12 |
| 1 | 1.52 | 0.00 | 1.96 | 5.14 | 4.55 | 5.18 | 1.8 | 2.97 | 3.45 | 3.87 | 3.87 | 3.34 |
| 2 | 1.06 | 2.48 | 5.04 | 2.8 | 5.06 | 6.08 | 4.5 | 3.49 | 3.39 | 5.12 | 5.12 | 4.61 |
| 3 | 4.99 | 2.29 | 2.09 | 0.82 | 0.98 | 6.83 | 3.71 | 5.27 | 3.92 | 4.56 | 4.56 | 3.68 |
| 4 | 2.56 | 3.13 | 2.14 | 1.35 | 1.51 | 7.03 | 4.5 | 4.67 | 4.84 | 6.26 | 6.26 | 5.83 |
| 5 | 0.00 | 0.00 | 0.00 | 0.00 | 0.00 | 0.00 | 1.98 | 2.16 | 1.78 | 0.00 | 0.00 | 0.00 |
| 6 | 1.04 | 0.00 | 0.00 | 1.07 | 0.00 | 0.00 | 1.7 | 1.32 | 1.63 | 0.00 | 0.00 | 0.00 |
| 7 | 0.00 | 0.00 | 0.00 | 0.00 | 0.00 | 0.00 | 1.63 | 1.08 | 1.42 | 0.00 | 0.00 | 0.00 |
| 8 | 0.76 | 0.00 | 0.00 | 0.00 | 0.00 | 0.00 | 1.28 | 1.39 | 1.24 | 0.00 | 0.00 | 0.00 |
| 9 | 0.00 | 0.00 | 0.00 | 1.08 | 0.00 | 0.00 | 1.86 | 1.46 | 1.42 | 0.00 | 0.00 | 0.00 |

The proportion of zero-demand periods was defined as z. Of the total parent products in the sample, around 52% exhibit z≥25% and about 26% exhibit z≥50%, which is equivalent to one and two quarters of zero demands, respectively. It was found that 216 or over 82% of all 263 child components with multiple parents in the sample have at least one parent product with z≥25% and 157 or 60% of child components have at least one parent product with z≥50%. In Table 3 it is shown that of the 263 child components with multiple parents at least half have five or more parent products and a quarter have thirteen (13) or more parent products, up to a maximum of 219 parents for a single child. Of these, at least a quarter have 6 or more parent products with z≥25% (up to a maximum of 103) and another quarter have four or more parents (up to a maximum of 39) with z≥50%.

TABLE 2
Contemporaneous correlation among parent
products' demand presented in Table 1.

| Fin- | | | | | | | | | |
|---|---|---|---|---|---|---|---|---|---|
| ished | | | | | | | | | |
| Good | 1 | 2 | 3 | 4 | 5 | 6 | 7 | 8 | 9 |
| 1 | 1 | 0.53 | 0.12 | 0.27 | −0.17 | −0.14 | −0.19 | −0.28 | −0.03 |
| 2 | 0.53 | 1 | 0.17 | 0.51 | −0.11 | −0.49 | −0.09 | −0.36 | −0.20 |
| 3 | 0.12 | 0.17 | 1 | 0.8 | 0.23 | 0.08 | 0.18 | 0.32 | −0.01 |
| 4 | 0.27 | 0.51 | 0.80 | 1 | 0.15 | −0.15 | 0.15 | 0.05 | −0.05 |
| 5 | −0.17 | −0.11 | 0.23 | 0.15 | 1 | 0.81 | 0.97 | 0.93 | 0.90 |
| 6 | −0.14 | −0.49 | 0.08 | −0.15 | 0.81 | 1 | 0.83 | 0.89 | 0.91 |
| 7 | −0.19 | −0.09 | 0.18 | 0.15 | 0.97 | 0.83 | 1 | 0.90 | 0.90 |
| 8 | −0.28 | −0.36 | 0.32 | 0.05 | 0.93 | 0.89 | 0.90 | 1 | 0.81 |
| 9 | −0.03 | −0.20 | −0.01 | −0.05 | 0.90 | 0.91 | 0.90 | 0.81 | 1 |

TABLE 3
Summary statistics for child components with
one-to-many parent relationships (263 components)
in the sample data.

| | Number | Number | |
|---|---|---|---|
| | of Parent | of Parent | |
| | Products | Products | Number |
| | Per child | Per child | of Parent |
| | component | component | Products |
| | with | with | Per child |
| | z ≥ 25% | z ≥ 50% | component |
| Minimum | 0.00 | 0.00 | 2.00 |
| First Quartile | 1.00 | 0.00 | 3.00 |
| Median | 3.00 | 1.00 | 5.00 |
| Mean | 6.79 | 3.14 | 14.35 |
| Third Quartile | 6.00 | 4.00 | 13.00 |
| Maximum | 103.00 | 39.00 | 219.00 |

The data from the sample demonstrates a high incidence of zero demand among the parent products, which highlights the need to test the intuition for the correct application of the univariate or multivariate approach when bootstrapping child component safety stocks. Table 4 provides a picture of the relative magnitude of the parent products' zero demands for child components. At least a quarter of all child components have 75% of all parent products with z≥25% and 39% of all parents with z≥50%. These proportions are used to inform the design of numerical experiments.

TABLE 4
Percentage summary statistics of child
components associated with more than
one parent product in sample data.

| | Percentage | Percentage |
|---|---|---|
| | of Parent | of Parent |
| | Products | Products |
| | Per Child | Per Child |
| | Component | Component |
| | with | with |
| | z ≥ 25% | z ≥ 50% |
| Minimum | 0.00% | 0.00% |
| First Quartile | 25.00% | 0.00% |
| Median | 50.00% | 15.79% |
| Mean | 50.54% | 25.99% |
| Third Quartile | 75.00% | 38.81% |
| Maximum | 100.00% | 100.00% |

### Theoretical Motivation

According to various embodiments, the present disclosure falls into two broad streams of the inventory management literature: (a) the compound distribution approach and, (b) risk pooling or statistical scale economies through component commonality. In the former stream, various embodiments of the present disclosure are described as a more general non-parametric bootstrap approach used to set safety stocks for components that exhibit non-standard LTD distributions. In the latter stream, the merits of the bootstrap non-parametric approach to set safety stocks for child components with stochastic lead times aggregated across multiple parents' stochastic demands in a multi-period, continuous review policy for a target CSL is discussed.

### Bootstrap Theory

Consider a child component with observed empirical lead times \tilde{L}={\tilde{l}₁, . . . , \tilde{l}ₙ_{_{\tilde{L}}}} and observed empirical demands of a single parent product \tilde{D}={\tilde{d}₁, . . . , \tilde{d}ₙ_{_{\tilde{D}}}}. The legacy method starts with constructing the b-th bootstrap re-sample of the empirical mixture of LTD, defined as \tilde{X}^{(b)}={x_{i,1}^{(b)}, . . . , x_{i,n}_{_{\tilde{L}}}^{(b)}} from the random sums of demands conditioned on lead time. For each bootstrap re-sample b=1, . . . , B, the i-th empirical mixture of LTD is

$${\tilde{x}}_{i}^{( b )} = {\sum }_{j = 1}^{{\tilde{l}}_{i}^{( b )}} {\tilde{d}}_{j}^{( b )}$$

where \tilde{l}ᵢ^{(b)} is randomly sampled with replacement from \tilde{L}ᵢ and \tilde{d}ⱼ^{(b)} is randomly sampled with replacement from \tilde{D}. The legacy method estimates the P₁-th bootstrap quantile

$${\hat{τ}}_{{P}_{1}}^{*} = \frac{1}{B} {\sum }_{( b ) = 1}^{B} {\hat{τ}}_{{P}_{1}}^{( b )}$$

where \hat{t}_{P}_{₁}^{(b)}=g_{P}_{₁}{\tilde{x}₁^{(b)}, . . . , \tilde{x}ₙ_{_{\tilde{L}}}^{(b)}} is the P₁-th sample quantile for the b-th bootstrap re-sample and g_{P}_{₁}(·) returns the P₁-th sample quantile of the vector input. Hence, the bootstrap is ROP \hat{τ}_{P}_{₁}* and the bootstrap safety stock is ss*=τ_{P}_{₁}*−μ_{\hat{X}} where

$${\hat{μ}}_{\hat{X}}^{*} = {\sum }_{b = 1}^{B} \frac{{\overline{x}}^{( b )}}{B} and {\overline{x}}^{( b )} = {\sum }_{m = 1}^{{n}_{\tilde{L}}} \frac{{\tilde{x}}_{m}^{( b )}}{{n}_{\tilde{L}}}$$

for the b-th bootstrap sample.

Now consider the case where inventory parameters such as ROP and safety stocks are set for a child component which is then used to produce q parent products. Define v to be the set of parent products of a child component. For parent product v ∈ v define the historic time series that make up the sample of demands

$${\tilde{D}}_{υ} = \{ {d}_{υ , 1} , … , {d}_{υ , {n}_{{\tilde{D}}_{υ}}} \} .$$

Assume that the true demand distribution has constant mean and is not serially correlated. From the BOM, wᵥ, the quantity of the child component needed to produce a unit of parent product v, is obtained. Just as before, lead times were defined \tilde{L}={\tilde{l}₁, . . . , \tilde{l}ₙ_{_{\tilde{L}}}}. When using the bootstrap, two cases must be considered: where parent product demand is correlated, or parent product demand is not correlated.

Case 1: Consider the case where for all j, k ∈ v cov (Dⱼ, Dₖ)≠0, implying a Σ covariance structure among parent product demands where the k-th diagonal element is (Σ)_{j,k}≠0 for j≠k. In this case a random sampling strategy for the demand in the bootstrap procedure must maintain the covariance structure among the parent product demand. For mathematical simplicity, assume n_{\tilde{D}}_{ᵥ}=nᵥ for all v ∈ v. To account for the correlation structure between parent products, first total the demands across all parent products' demands for each period and then sample the demands from that time series of aggregated parent products' demands. This means that the i-th LTD mixture for the b-th bootstrap sample of the child component is defined as

$${\tilde{x}}_{i}^{( b )} = {\sum }_{j = 1}^{{\tilde{l}}_{i}^{( b )}} {\tilde{u}}_{j}^{( b )}$$

where each ũⱼ^{(b)} is randomly sampled with replacement from the set {u₁, . . . uₙ_{ᵥ}} such that uⱼ=Σ_{v∈v}d_{j,v}Wᵥ where j=1, . . . , nᵥ is the time periods. By resampling uⱼ, the sum of the demands of parent products at time point j, the sample correlation structure is maintained between parent products. This approach is called the univariate bootstrap because the sample is from a single vector of parents' demand aggregated in a single time series.

Case 2: Consider the case where cov(Dⱼ, Dₖ)=0, ∀(j, k) ∈ v implying no covariance structure among parent product demands such that Σ is a diagonal matrix where (Σ)_{k,k}=σ_{D}_{ₖ}², and (Σ)_{m,k}=0 for all m, k such that m≠k. The modification proposed to the legacy method when the parent product demands are not correlated is the i-th empirical mixture of LTD in each b-th bootstrap re-sample is \tilde{x}ᵢ^{(b)}=Σⱼ₌₁^{l}^{ᵢ}^{^{(b)}}Σ\tilde{d}_{v,j}^{(b)}Wᵥ where each \tilde{d}_{v,j}^{(b)} is randomly sampled with replacement from \tilde{D}ᵥ∀v ∈ v. This procedure is called the multivariate bootstrap, because for each \tilde{x}ᵢ^{(b)}-th LTD mixture the demand is randomly sampled from the time series vector of each parent product's demand rather than a single aggregated vector. This is equivalent to randomly sampling \tilde{l}ᵢ observations from each \tilde{D}ᵥ v ∈ v to create the empirical mixture. A benefit of this approach when compared to the univariate bootstrap is that it leads to more possible combinations of sums of the demands.

Note that in either case when q=1 the multivariate and univariate bootstrap default to that of the legacy method. The modification to the legacy method that accounts for the one-to-many relationship of a child component with its multiple parent products, leverages the statistical scale economies from pooling the variance of the parent products' demand while maintaining the parent products' demand covariance structure. To examine this, consider X to be the random variable of LTD for the component used in q finished goods and L is the random variable for the replenishment lead time for the component that has mean μL and variance σ_{L}². As the component has q parent products is assumed, D is defined as D=(D₁, . . . , D_{q})^{T} to be a q dimensional random variable with mean μ_{D}=(ν_{D}_{₁}, . . . , μ_{D}_{_{g}})^{T}, and q by q covariance matrix Σ, such that element j, j of Σ is Var(Dⱼ)=σ_{D}_{ⱼ}², and element j, k, j≠k is Cov (Dⱼ, Dₖ). Writing out the mean and variance under each of these elements is somewhat more detailed than a case with only a single parent product. In this case, the variance of lead time demand is,

$$Var ( X ) = {μ}_{L} ( {\sum }_{j = 1}^{q} {σ}_{{D}_{j}}^{2} + 2 {\sum }_{j = 1}^{q - 1} {\sum }_{k = j + I}^{q} Cov ( {D}_{j} , {D}_{k} ) ) + {{σ}_{L}^{2} ( {\sum }_{j = 1}^{q} {μ}_{{D}_{j}} )}^{2} .$$

Hence, the covariance of the parent products' demand directly affects the variability of LTD. This is similar to how statistical scale economies affect LTD where higher positive covariances reduce the pooling effect and higher negative covariances increase the pooling effect.

The methods proposed only consider relationships between parent products under stationary demand. Regardless of the correlation among parent products' demand, if serial correlation is of concern, the bootstrap sampling of parent products' demand can be augmented to consider consecutive time points. Furthermore, if one were to use forecast demands as an alternative to historic demands, and demand was no longer a stationary process, a parametric bootstrap of the forecast errors among many other approaches could be used to account for this added complexity.

### Research Design and Simulation

Operations managers in production and procurement planning groups assert that demand among parent products' are not contemporaneously correlated. The small sample sizes (n_{D}=12) make it impossible to accurately estimate covariances to in/validate their assertion. Hence, a controlled simulation study is undertaken where highly correlated demand is generated to investigate the performance of the multivariate and univariate bootstrap approaches. Incorporated into the simulation design is multiple instances of zero demands to replicate the periods of zero demands observed in the sample data due to the production campaigns responding to volatile market demands. In doing so, the effect of using the multivariate bootstrap approach even when the demand among parent products is correlated and can be assessed.

In FIGS. 20A-20C, it is shown that if parent products' demand are independent, the multivariate approach will provide more accurate estimates of safety stocks in small sample sizes. Hence, in this simulation, the multivariate bootstrap approach undergoes stress testing by using an extremely high level of correlation that will severely bias the multivariate bootstrap estimates vis-à-vis the univariate bootstrap. Furthermore, by randomly adding different levels of zero demands to parent products, the effects of the high frequency of zero demands observed in the sample data can be understood. The expectation was that the zero demands will (a) induce a zero inflated bimodal distribution of pooled demand, (b) mitigate the prevailing demand correlation among parent products, and (c) with high frequency of zero demand introduce pseudo-correlation as observed in Table 2. While the bimodal distribution will degrade the textbook (Normal and Gamma) estimates, the pseudo-correlation will reduce the bias of the multivariate relative to the univariate bootstrap approach.

### Data Generating Model

Demand for a single child component that goes into q parent products is generated as follows. First, n_{D} periods of demand is generated where conditional non-zero demand for the parent products in a period are realizations of a q-dimensional, multivariate Lognormal distribution with mean μ covariance matrix Σ. Experimental conditions with well-behaved underlying distributions were studied where textbook estimators such as the Normal and Gamma should yield accurate safety stock estimates. It is assumed that the first 0.2q elements of μ are equal to 1,000 while all others are equal to 100. The variance of each product's demand is set to 400, the correlation of all parent products (corresponding to the off-diagonal elements of Σ) to ρ. In order to stress test the multivariate bootstrap approach, (q, ρ) ∈ {10}×{0.5, 0.9} is studied where q is motivated by observations from the sample data presented above. Note that it is not considered that ρ=0 since it is known that the multivariate provides the closest estimates when parent demand is independent in small sample sizes as evident in FIGS. 20A-20C. It is taken that n_{D}=12 because the sample data only relied on the last 12 months of parent demand data. It is assumed that each parent product has z*n_{D} zero demand entries where (z)∈ {0, 0.25, 0.5}. As higher frequency of zero demands is added, it is expected that the accuracy of the textbook approaches deteriorate due to the non-standard shape of the zero inflated pooled demand distribution. In addition, increasing the frequency of zeroes will break down the prevailing correlation structure reduce estimation accuracy gap between the univariate bootstrap (U-boot) and the multivariate bootstrap (M-boot). For these approaches to be scalable across an entire portfolio of procurement items, they must accommodate multiple CSL targets. Hence, for evaluation the MAPE is used for the 80^{th}, 85^{th}, 90^{th}, and 95^{th} percentiles across 50 independent replications of each setting.

### Simulation Results

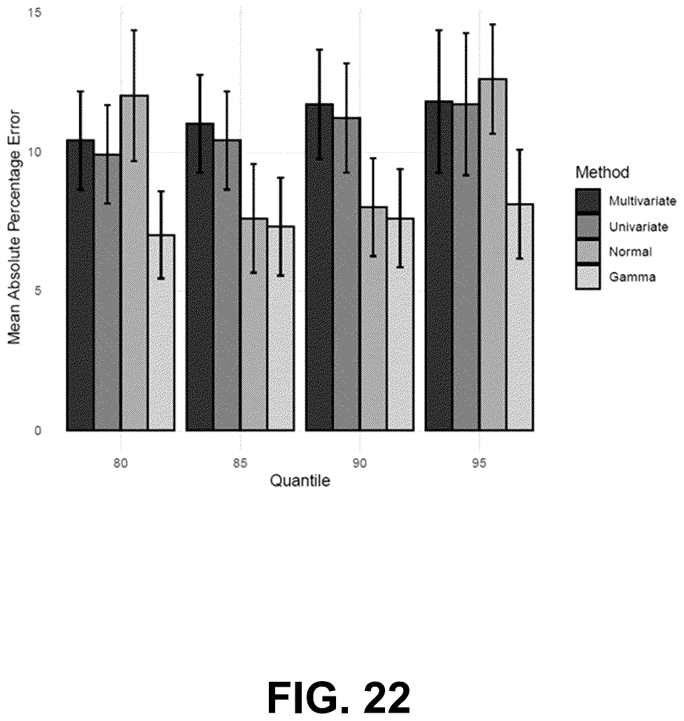

The full simulation results are available in Table 5 where the MAPE and standard errors of each method's safety stock estimate is reported from the true across all experimental levels. In FIG. 22 the case for ρ=0.9 and z=0 across all CSL experimental levels is visualized where the multivariate bootstrap approach should display the lowest accuracy. As expected, when using a multivariate Lognormal to represent demands and Gamma to represent lead time, the Gamma method outperforms all methods. Interestingly, in small sample sizes even at the unrealistically high level of correlation the multivariate is competitive with the univariate bootstrap.

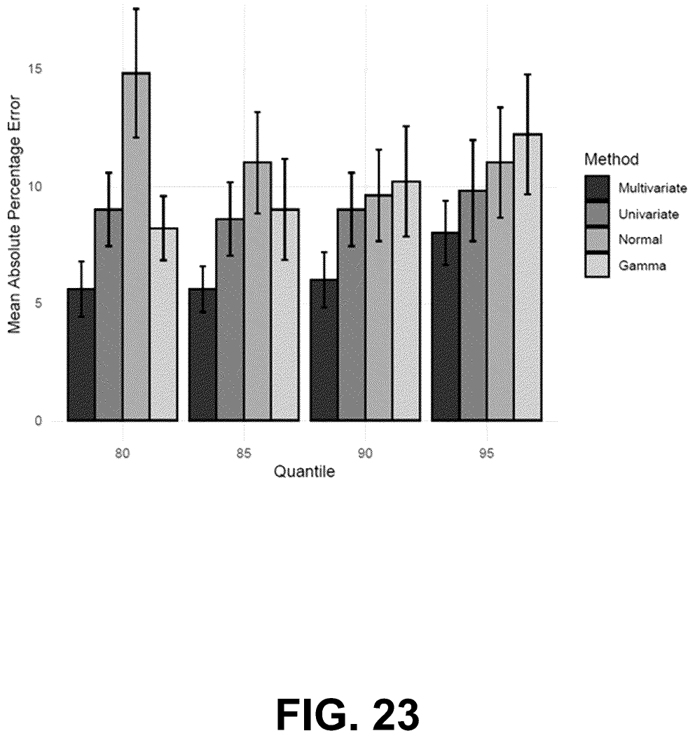

In FIG. 23, an extract of Table 5 is presented when z=0.50 and ρ=0.9. As expected, the textbook Normal and Gamma estimation deteriorates in the presence of the non-standard zero-inflated bimodal distributions of pooled demand. However, even at the high correlation of ρ=0.9 the multivariate bootstrap estimates are significantly better from the univariate for three out of the four quantiles.

These results support the advice to use the multivariate bootstrap approach for setting component safety stocks when parent products' demands exhibited frequent zero demands in small sample sizes. As the controlled experiment's results demonstrate, in small sample sizes the zero demands result in pseudo correlations that mitigate even very strong contemporaneous correlation structures among parent products' demands. The sample demand data exhibit a high frequency of zero demand as indicated above. In addition, as only 12 demands were used for each parent product at any point in time, correlation cannot be tested due to the low power of the test. Consequently, the multivariate bootstrap approach was implemented, which is discussed next.

TABLE 5
Mean absolute percentage error for safety stock estimates for each of the four methods studied
in the simulation, to estimate safety stocks at the 80th, 85th, 90th, and 95th quantiles
when z = {0.00, 0.25, 0.50} and ρ = {0.5, 0.9}.

| | | Multivariate | Univariate | Normal | Gamma |
|---|---|---|---|---|---|
| z = 0.00 | 80 | 0.111 (0.013) | 0.108 (0.012) | 0.103 (0.010) | 0.073 (0.008) |
| | 85 | 0.107 (0.010) | 0.105 (0.010) | 0.081 (0.008) | 0.077 (0.008) |
| | 90 | 0.101 (0.010) | 0.100 (0.010) | 0.090 (0.010) | 0.081 (0.009) |
| | 95 | 0.115 (0.011) | 0.112 (0.011) | 0.146 (0.011) | 0.085 (0.009) |
| ρ = 0.50, | 80 | 0.075 (0.009) | 0.081 (0.008) | 0.131 (0.012) | 0.067 (0.006) |
| z = 0.25 | 85 | 0.073 (0.008) | 0.076 (0.008) | 0.096 (0.008) | 0.080 (0.006) |
| | 90 | 0.079 (0.008) | 0.080 (0.008) | 0.075 (0.006) | 0.089 (0.006) |
| | 95 | 0.096 (0.008) | 0.097 (0.008) | 0.090 (0.010) | 0.097 (0.007) |
| z = 0.50 | 80 | 0.069 (0.005) | 0.076 (0.008) | 0.130 (0.012) | 0.073 (0.008) |
| | 85 | 0.073 (0.008) | 0.079 (0.008) | 0.092 (0.009) | 0.077 (0.008) |
| | 90 | 0.081 (0.007) | 0.084 (0.009) | 0.083 (0.008) | 0.086 (0.008) |
| | 95 | 0.100 (0.009) | 0.095 (0.010) | 0.110 (0.010) | 0.100 (0.009) |
| z = 0.00 | 80 | 0.104 (0.009) | 0.099 (0.009) | 0.120 (0.012) | 0.070 (0.008) |
| | 85 | 0.110 (0.009) | 0.104 (0.009) | 0.076 (0.010) | 0.073 (0.009) |
| | 90 | 0.117 (0.010) | 0.112 (0.010) | 0.080 (0.009) | 0.076 (0.009) |
| | 95 | 0.118 (0.013) | 0.117 (0.013) | 0.126 (0.010) | 0.081 (0.010) |
| ρ = 0.90. | 80 | 0.090 (0.008) | 0.102 (0.008) | 0.110 (0.011) | 0.072 (0.006) |
| z = 0.25 | 85 | 0.083 (0.008) | 0.090 (0.008) | 0.082 (0.009) | 0.077 (0.007) |
| | 90 | 0.080 (0.009) | 0.084 (0.008) | 0.082 (0.008) | 0.081 (0.008) |
| | 95 | 0.100 (0.010) | 0.100 (0.010) | 0.120 (0.010) | 0.087 (0.009) |
| z = 0.50 | 80 | 0.056 (0.006) | 0.090 (0.008) | 0.148 (0.014) | 0.082 (0.009) |
| | 85 | 0.056 (0.005) | 0.086 (0.008) | 0.110 (0.011) | 0.090 (0.009) |
| | 90 | 0.060 (0.006) | 0.090 (0.008) | 0.096 (0.010) | 0.102 (0.011) |
| | 95 | 0.080 (0.007) | 0.098 (0.011) | 0.110 (0.012) | 0.122 (0.013) |

### INDUSTRY APPLICATION

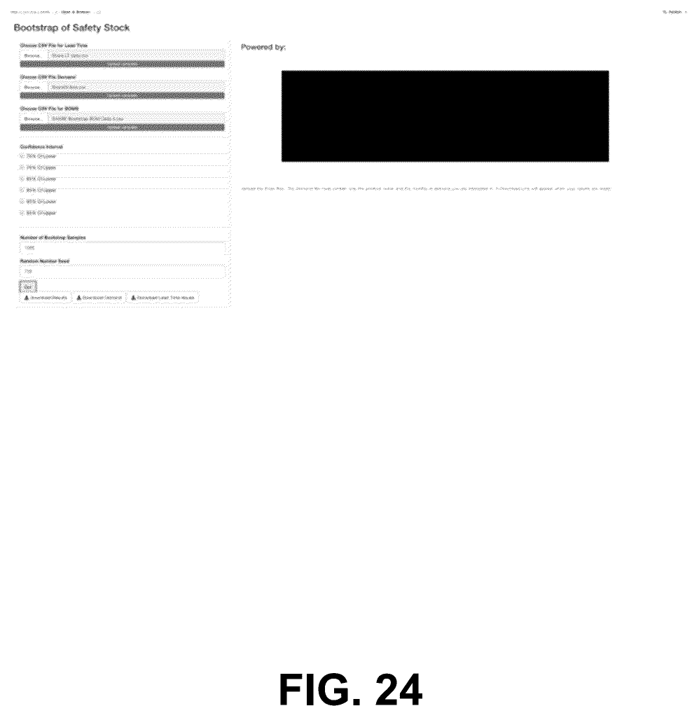

For this application, any solution provided needed to be scaled to all child components in the portfolio which are set at a variety of CSL. Hence, for implementation, a simple graphical user interface was developed in Shiny® and hosted on Amazon Web Services (AWS). The application is secured by a single sign-on portal for analysts. The application allows the team of analysts to upload one or more structured output files. For example, a structured output file may include a delimited text file, a CSV (comma-separated values) file, and/or any other suitable structured output file structure. In various examples, a structured output file comprises a table of rows and columns where each row corresponds to a record of data and each column corresponds to a data field for a type of data included in the column. Here, the analysts upload three comma separated value (CSV) files: the first consisting of child component SKUs and the respective lead times for historic orders, a second consisting of the corresponding parent products and their demand, and the third consisting of the BOM file that relates the child components to their parent products' consumption rates/unit demand. The analysts set CSL targets for every child component. The interface can be seen in FIG. 24. After the files are processed and the analyst has initiated the program, the results can be downloaded as structured output files containing safety stock estimates, and estimated confidence intervals set by the analysts using the legacy method. In addition, two auxiliary or diagnostic files (FIG. 24) are available that detail data quality issues in the lead-time and demand files to provide quality control checks for the safety-stock estimates. These files detect issues ranging from insufficient demand data, to missing lead-time data for SKUs found in the BOM file. The diagnostic files provide protection against errors in data entry and formatting for the applications input files.

### Implementation Results

There were twelve (12) months of data corresponding to an implementation conducted for the sample. Analysts would extract data from the ERP system, which includes historic demand for parent products; in some cases a maximum of three months of a three-month ahead moving average demand forecast is used (that the analysts assumed to be from the same stationary demand process). Target CSLs range from 80% to 99%. The implementation across the portfolio of child components began in July 2019. The AWS hosted Shiny App takes two analysts only eight hours to set safety stocks for over 300 components with input from the production and planning group. Compare this to forty (40) hours with the legacy approach. Within the implementation period roughly 180 of the 343 total components in the portfolio were being directly set by the bootstrap estimates. The rest were manually altered due to management overrides such as minimum lot-sizes and transportation economies.

A subset of child components were investigated to get a sense of the efficacy of the proposed bootstrap approach by comparing the inventory performance before implementation (pre-implementation) to that after implementation in July 2019 (post-implementation). The subset of child components was selected by the analysts as they were identified as “high volume movers” over the implementation period. The pre-implementation period inventory performance results for January 2017-June 2019 (including 176 order cycles) were compared to that of the post-implementation period July 2019-March 2020 (including fifty-one (51) order cycles). In the pre-implementation period a 100% CSL target was achieved over the seventeen (17) products compared to an 88% CSL target during the post-implementation period. The post-implementation CSL is within the range of CSL targets used to calculate the safety stocks of the set of seventeen (17) components. In addition, the within product differences of the seventeen (17) components based on the percentage change in average actual safety stock, which are defined as:

$$\frac{\begin{matrix}( Average Pre - Implementation Stock on Hand ) - \\ ( Average Post - ImplementationStockonHand )\end{matrix}}{( Average Pre - Implementation Stock on Hand )}$$

were compared. The difference between the average bootstrap estimate and the average legacy estimate over the post-implementation period, which is defined as:

$$\frac{( Average Legacy Estimate ) - ( Average Bootstrap Estimate )}{( Av erage Legacy Estimate )}$$

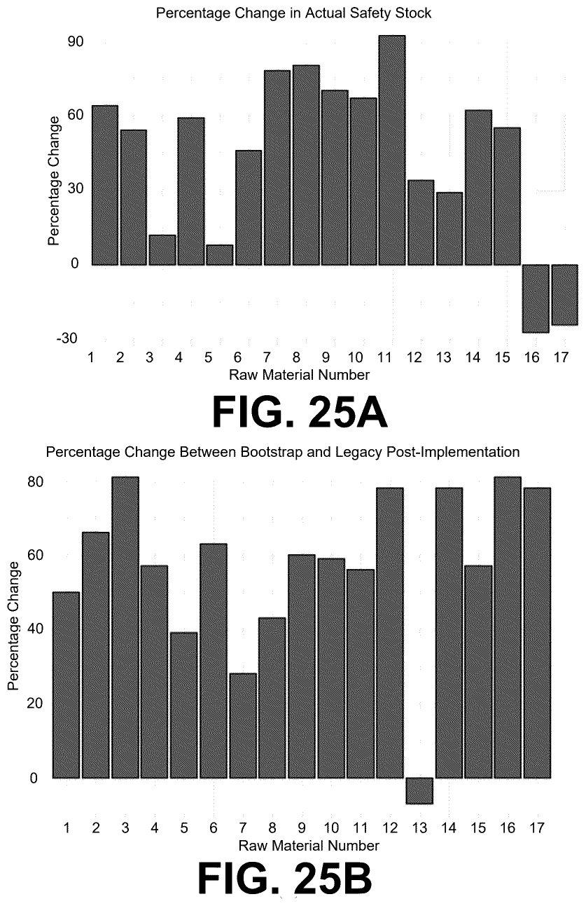

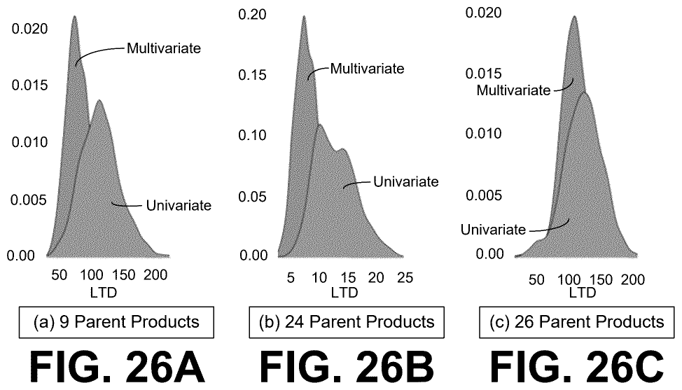

was also calculated. FIGS. 25A-25B present the results of this study for the seventeen (17) selected components. In FIG. 25A a decrease in the average stock-on-hand post-implementation is shown for all components except for components sixteen (16) and seventeen (17). Further investigation showed a significant increase in demand for the parent products associated with these components over the latter part of the post-implementation period. These raw components also experienced stockouts, which were related to this extreme increase in demand. It is noted that this also coincided with the rare event of a global pandemic that began early in 2020. In FIG. 25B the results also show substantial decrease in the safety stock estimates using the bootstrap when compared to the legacy estimates in the post-implementation period. The exception is component 13 which shows that bootstrap sets the safety stock 7% higher than legacy. In total, the differences between the bootstrap and legacy safety stocks netted $600,000 savings for the subject from lower inventory levels. The subject directly freed $2 million cash from lower inventory levels enabled by employing the multivariate bootstrap to set safety stocks for all components. The reduced physical stock enabled an additional 60% savings in warehouse space, obviating the need to invest in expanded warehouse capacity.

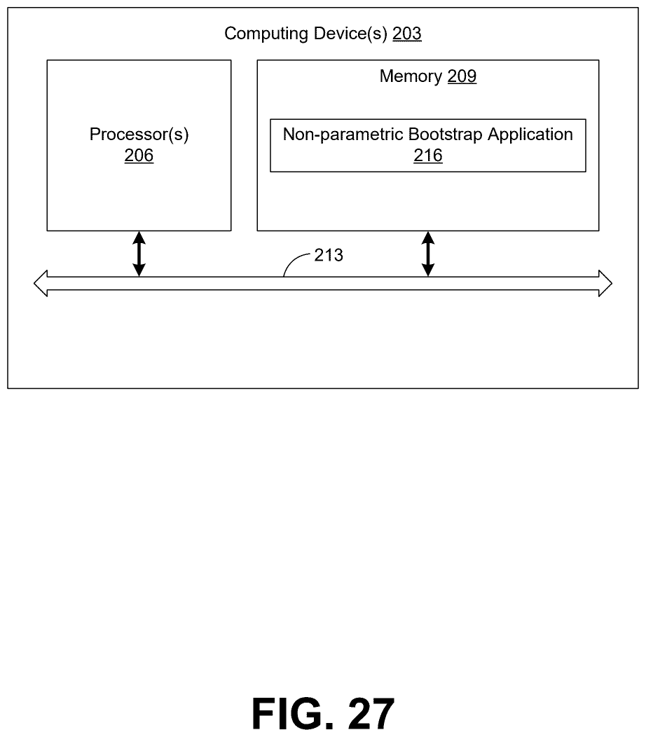

With reference to FIG. 27, shown is a schematic block diagram of one or more computing devices 203. Each computing device 203 includes at least one processor circuit, for example, having a processor 206 and a memory 209, both of which are coupled to a local interface 213. To this end, each computing device 203 may comprise, for example, at least one server computer or like device. The local interface 213 may comprise, for example, a data bus with an accompanying address/control bus or other bus structure as can be appreciated.

Stored in the memory 209 are both data and several components that are executable by the processor 206. In particular, stored in the memory 209 and executable by the processor 206 is the non-parametric bootstrap application 216 and potentially other applications. Also stored in the memory 209 may be a data store 219 and other data. In addition, an operating system may be stored in the memory 209 and executable by the processor 206.

It is understood that there may be other applications that are stored in the memory 209 and are executable by the processor 206 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 209 and are executable by the processor 206. In this respect, the term “executable” means a program file that is in a form that can ultimately be run by the processor 206. Examples of executable programs may be, for example, a compiled program that can be translated into machine code in a format that can be loaded into a random access portion of the memory 209 and run by the processor 206, source code that may be expressed in proper format such as object code that is capable of being loaded into a random access portion of the memory 209 and executed by the processor 206, or source code that may be interpreted by another executable program to generate instructions in a random access portion of the memory 209 to be executed by the processor 206, etc. An executable program may be stored in any portion or component of the memory 209 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 209 is defined herein as including both volatile and nonvolatile memory and data storage components. Volatile components are those that do not retain data values upon loss of power. Nonvolatile components are those that retain data upon a loss of power. Thus, the memory 209 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random-access memory (SRAM), dynamic random-access memory (DRAM), or magnetic random-access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 206 may represent multiple processors 206 and/or multiple processor cores and the memory 209 may represent multiple memories 209 that operate in parallel processing circuits, respectively. In such a case, the local interface 213 may be an appropriate network that facilitates communication between any two of the multiple processors 206, between any processor 206 and any of the memories 209, or between any two of the memories 209, etc. The local interface 213 may comprise additional systems designed to coordinate this communication, including, for example, performing load balancing. The processor 206 may be of electrical or of some other available construction.

Although the non-parametric bootstrap application 216 and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Many aspects of the present disclosure can be better understood with reference to the following example, which is hereby incorporated by reference in its entirety.

### Example 1: Paper Entitled “a Non-Parametric Approach for Setting Safety Stock Levels.”

### Example 1

In practice, lead time demand (LTD) can be non-standard: skewed, multi-modal or highly variable; factors that compromise the validity of the typical approaches commonly used for setting safety stock levels. Motivated by encountering this problem at the industry partner, an approach is developed for setting safety stock levels using the bootstrap, a widely-used statistical procedure. Existing bootstrap approaches for inventory management either operate directly on observed LTD or assume deterministic lead times, permitting direct application of the bootstrap approach for univariate quantile estimation. As LTD is a convolution of multiple random demands over a random lead time, a multivariate bootstrap approach is required. As demonstrated, when lead times are stochastic, the multivariate approach provides improved safety stock estimates. A multivariate central limit theorem is developed for the bootstrap mean and bootstrap quantile-components of the safety stock calculation-highlighting why the generalization of these bootstrap methods is critical for inventory management. These results provide a theoretical underpinning for the bootstrap estimator of safety stock and permit the construction of confidence intervals for safety stock estimates, allowing decision makers to understand the reliability with which the desired service level will be achieved. Building on the theoretical results, and supported by numerical experiments, insights are provided on the behavior of the bootstrap for various LTD distributions, which the results demonstrate are critical when employing the bootstrap method. Implementation of the approach with the industry partner resulted in an inventory investment reduction of $1.17 million combined with an overall increase in service level. The approach is general and can be implemented without modification in other settings.

### 1. Introduction

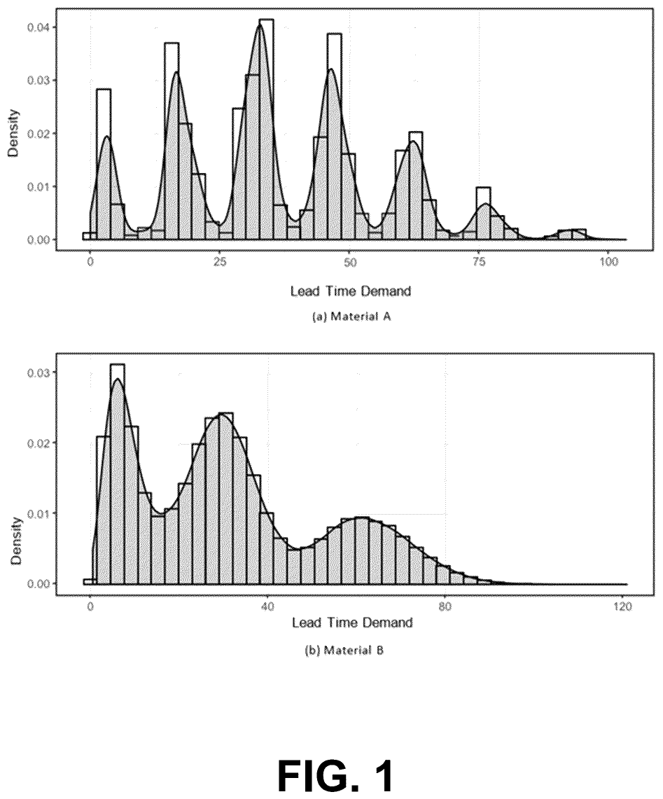

Setting appropriate safety stock levels is an important decision for firms in many industries. For several years, global sourcing has continued to grow leaving firms to face long and variable lead times. While recent disruptive events, including the COVID-19 pandemic, may spur firms to revisit their global sourcing strategies, this shift will take time. Furthermore, lead time demands (LTD) that are highly variable can still persist with domestic suppliers due to multiple sources of uncertainty, such as unpredictable manufacturing environments, potential disruptions to transportation and distribution infrastructure, and potentially permanent shifts in consumer demand patterns. The textbook approach to setting safety stocks assumes that LTD follows a known distribution (e.g., normal), but it is well documented that LTD can be skewed, multi-modal or highly variable. When these factors are present, and compromise the validity of distributional assumptions, widely-used classic approaches, also promulgated in textbooks, may produce poor results. This is precisely the problem encountered at the industry partner (anonymized as “MakerCo”) where lead-time demands were not well represented with standard distributions and attempts to apply standard approaches, even with managerial interventions, were unsuccessful. MakerCo is a large, global manufacturer of discrete products, and limited shelf-life raw materials are each used in the production of each finished product. These materials are sourced from international suppliers where limited production capacity from batch manufacturing campaigns and unreliable transit times contribute to long, stochastic lead times that frequently exhibit left- or right-skew and multi-modality. In addition, MakerCo experiences volatility in the demand for finished products, and thus the dependent raw material demand. These factors combine to result in LTD distributions that are skewed and multi-modal. FIG. 1 shows estimated LTD distributions for two of MakerCo's raw materials. Described herein are the development and implementation of the data-driven approach at MakerCo, using a non-parametric bootstrap approach to setting safety stocks to meet a service level for probability of not stocking out during a replenishment cycle (commonly known as a P1 service level). Safety stocks are a function of service level and, demand and replenishment lead-time uncertainty. Hence, the focus is on safety stock estimation as is the norm in the literature. Furthermore, widely used ERP systems such as, SAP, require the entry of calculated safety stocks for production planning purposes.

There are both theoretical and methodological contributions of this work, as the statistical theory for the safety stock estimator, and the bootstrap safety stock estimator have not been developed or explored in the literature. This research makes the following contributions to both the academic literature and to practice:
1. Approaches based on distributional assumptions are common in the literature and widely used in practice. These approaches may result in biased estimates in the presence of non-standard LTD distributions with variable lead times. To address this shortcoming, a non-parametric bootstrap approach is developed to estimate safety stocks to meet a target service level (P1) that provides both accurate estimates as well as statistically valid confidence intervals.
2. Theoretical grounding is provided for preserving the correlation structure between the P1-implied quantile and the mean of LTD to develop the safety stock estimator, which is necessary to provide reliable estimates of safety stock. This theory guides the practical implementation of the methodology.
3. The approach bootstraps safety stock estimates directly from lead time and demand data by creating a sampling distribution of the safety stock estimator without burdensome assumptions. This enables the construction of confidence intervals for additional guidance to operations managers.
4. Enterprise resource planning (ERP) systems in wide use including at MakerCo, do not collect LTD data, precluding the use of the Bookbinder and Lordahl (1989) bootstrap approach. Even if LTD data are available, it is demonstrated that the Bookbinder and Lordahl (1989) approach can produce biased results.
5. While the work on this problem was motivated by conditions at MakerCo, the approach is general and can be implemented without modification in other settings. The approach is either computationally-nor user-intensive and can easily scale across many items.

In Section 2, the theoretical grounding for the bootstrap safety stock estimator is outlined. As the theoretical results apply to asymptotic settings, in Section 3, the results of controlled numerical experiments are presented in a finite sample setting designed to provide insights of the bootstrap performance compared to a known true benchmark. In Section 4, the implementation at MakerCo is presented highlighting the practical impact of this research. In Section 5, a discussion of the results, contributions and limitations is presented with suggestions for future research.

In this section, it is shown that there exists a central limit theorem for safety stock and bootstrap of safety stock when LTD is known, both of which have a non-negligible covariance structure that is computationally intractable without heavy distributional assumptions. This shows that calculating the safety stock for each bootstrap sample, as proposed, will account for this covariance structure. Then the bootstrap safety stock estimate is provided for the case where periodic demand and lead time data are collected independently precluding the construction of LTD data, which is the case in most ERP systems and also motivates the classic Hadley and Whitin (1963) approach.

### 2.1 a Bootstrap Safety Stock Estimator Central Limit Theorem

To formulate the asymptotic results, consider the setting where LTD can be observed directly. Consider x1, . . . , xn as the sample of lead-time demands akin to the bootstrap setting in Bookbinder and Lordahl (1989). The distributions of both the sample mean and sample quantile are known, and asymptotic covariance between the sample mean and sample quantile is non-zero and could be considered intractable for non-standard distributions of LTD. Thus, the bootstrap could be used to create confidence intervals on safety stock in general settings. Moreover, the asymptotic properties of the bootstrap estimates of sample quantiles are known and well understood.

A new result is provided which defines joint asymptotic properties of the bootstrap mean and bootstrap quantiles. By defining this joint distribution, a central limit theorem for the bootstrap estimator of safety stock can be provided. The theorem is presented in the context of LTD but it applies more generally.

Theorem 1. Let x1, . . . , xn, the observed LTD, be random draws from a random variable, X, with distribution function FX(x), density fX(x), mean μ, variance σ2, and empirical distribution function Fn(x). Let 0<p<1 so that FX(Tp)=p. Assume fX(x) is continuous and positive at Fₓ⁻¹(p). Let Fₙ(Yp)=p, and

$$\overline{x} = {\sum }_{i = 1}^{n} {x}_{i} / n$$

Also assume FX is twice differentiable at the p-th quantile. Let x₁*, . . . , xₙ* represent a bootstrap sample of size n (sampling with replacement) from the sample of lead time demands x₁, . . . , xₙ. Define the empirical distribution function of the bootstrap sample as Gn such that Gn(Yp*)=p. Finally define x̅*=n−Σᵢ₌₁ⁿxᵢ*, then as n tends to infinity,

$$\sqrt{n} ( ( \begin{matrix}{\overline{x}}^{*} \\ {Y}_{p}^{*}\end{matrix} ) - ( \begin{matrix}\overline{x} \\ {Y}_{p}\end{matrix} ) ) {\to }^{L} {N}_{2} ( ( \begin{matrix}0 \\ 0\end{matrix} ) , ( \begin{matrix}{σ}_{x}^{2} & \frac{k ( p )}{{f}_{X} ( {F}_{X}^{- 1} ( p ) )} \\ \frac{k ( p )}{{f}_{X} ( {F}_{X}^{- 1} ( p ) )} & \frac{p ( 1 - p )}{{f}_{X} ( {F}_{X}^{- 1} ( p ) )}\end{matrix} )$$

where K(p)=E(Lp(X, F_{X}⁻¹(p)), such that Lp(z, a)=p(z−a)|(z≥a)+(1−p)(z−a)|(a<z).

It is of note that the asymptotic covariance term is non-zero if K(p)=0. Ferguson (1998) describes this as the minimum p-th deviation around F−1(p). Even if the distributions are standard, the covariance terms that include the quantity K(p) are still difficult to calculate directly, making bootstrap estimation an attractive alternative. The significance of this result is the multivariate normality of the estimators, and the ability to explicitly state the covariance structure. Next, this result is extended directly to safety stock.

Corollary 1. Assume the settings detailed in Theorem 1 hold, then

$$\sqrt{n} ( {Y}_{p}^{*} - {\overline{x}}^{*} - ) {\to }^{L} N ( 0 , {σ}_{SS}^{2} ) where$$

$$= {Y}_{p} - \overline{x} and {σ}_{SS}^{2} = {σ}_{X}^{2} + \frac{p ( 1 - p )}{{f}_{X}^{2} ( {F}_{X}^{- 1} ( p ) )} - 2 \frac{k ( p )}{{f}_{X} ( {F}_{X}^{- 1} ( p ) )} .$$

The proof of the corollary follows directly from Theorem 1. Corollary 1 guides the implementation of the bootstrap approach proposed for estimating safety stock, as it shows the distribution of safety stock is impacted by the covariance of the estimated bootstrap mean and estimated bootstrap quantile. Theorem 1 also shows that asymptotically there is a non-negligible relationship between the two statistics that yield safety stock when using bootstrap. The methodological implication of this result is when safety stock is calculated directly for each bootstrap sample the covariance structure for each bootstrap sample is maintained, and a sampling distribution of the statistic is preserved. This enables the estimation of bootstrap confidence intervals for safety stock. Should the two quantities be bootstrapped independently and difference of estimates taken, then the covariance structure is ignored, and the information of the sampling distribution is lost. Corollary 1 provides the transformation directly to the safety stock calculation, which show how the covariance structure plays a role in the variance of safety stock. This is the first work to explicitly define the variance of safety stock and suggest the statistical properties such as confidence intervals of safety stocks be investigated. With this in mind, the variance component required for inference is difficult to calculate without distributional assumptions. Thus, in practice whether LTD is observed or in a compound distribution setting, the bootstrap procedure for safety stock is an attractive procedure for estimation of safety stock and provides variance estimation to provide statistically valid confidence intervals.

### 2.2 Bootstrap Safety Stock Estimator

Assume that observed lead times are independent random draws from the random variable L which has mean μ_{L} and variance σ_{L}². It is also assumed that demand is stationary and randomly drawn from the random variable D which has mean μD and variance σ_{D}². Note that other types of non-stationary demand can be considered by using forecast errors, or block sampling, as the goal is to bootstrap quantiles of the LTD distribution, not demand directly. Furthermore, assume that lead time and demand are independent random variables. In practice correlation between lead time and demand data is seldom encountered making this independence assumption relevant as represented in the widely-used classic Hadley and Whitin (1963) approach.

The motivation for this approach is to generate LTD samples from the correct underlying LTD distribution with limited assumptions. The goal is to produce valid bootstrap samples of LTD while providing estimates of not only the safety stock but operationally relevant parameters such as statistically valid confidence intervals. As previously mentioned the proposed methodology scales to non-stationary demand, as the goal is to generate relevant LTD data for the underlying system.

Assume observations of LTD to be a realization of the random variable X with mean μX and variance σ_{X}². Under the classic Hadley and Whitin (1963) compound distribution approach, the estimates of the mean and variance of lead time (\hat{μ}_{L}), \hat{σ}_{L}²) and, the estimates of the mean and variance of demand (μ\hat{ }D, σ_{D}²) are used to estimate the mean of LTD \hat{μ}_{X}=\hat{μ}_{L}\hat{μ}_{D} and its variance \hat{σ}_{X}²=\hat{μ}_{L}\hat{σ}_{D}²+\hat{μ}_{D}²\hat{σ}_{L}². The focus in this research is on the estimation of safety stock, which is defined in the familiar way as SS=T−μX where T=F_{X}⁻¹(P₁) such that F_{X}⁻¹ is the inverse cumulative distribution function (CDF) of X. For example, the safety stock estimate under the normal distribution assumption is calculated as SS=F_{Z}⁻¹(P₋₁)\hat{σ}_{X}, where F_{Z}⁻¹(·) is the CDF of the random variable Z˜N (0, 1) for a P1 service level.

At MakerCo the setting typical of most information and ERP system installations was encountered, which are not configured to capture or tabulate LTD data but where demand and lead time data can be independently recorded and tabulated. In such a setting, it is observed Li, i=1, . . . , n_{L̅} and demands dj, j=1, . . . , n_{D̅} both independent draws from L and D respectively. The b-th bootstrap sample of LTD is \tilde{x}₁^{(b)}, . . . , \tilde{x}ₙ_{_{L̅}}^{(b)} such that the ith observation is \tilde{x}ᵢ^{(b)}=Σⱼ₌₁^{\tilde{l}}^{ᵢ}\tilde{d}ⱼ where each Ïᵢ is randomly selected with replacement from l₁, . . . , lₙ_{_{L}}, and each \tilde{d}ⱼ, j=1, . . . , \tilde{l}ᵢ is randomly selected with replacement from all d₁, . . . , dₙ_{_{\tilde{D}}}. Note that by sampling with replacement from both the empirical lead time and empirical demand, a sampling of all possible LTD observations with replacement is generated. It is chosen that m=n_{\tilde{L}} (the bootstrap sample size) as it makes intuitive sense that the number of LTD data in the sample should be limited to the number of lead times. This intuition matches the asymptotic convergence rate of Theorem 1. Numerical validation for m=n_{\tilde{L}} is provided in Section 3, which also demonstrates that confusion about bootstrap sample sizes as m=B (the number of bootstrap replications) arising from Monte Carlo methods that construct LTD mixtures from bootstrapped demand will result in biased estimates.

Calculate the bootstrap safety stock as SS*=B⁻¹Σ_{b=1}^{B}SS^{(b)}, where SS^{(b)}=Y^{(b)}−n_{\tilde{L}}⁻¹Σᵢ₌₁ⁿ^{_{\tilde{L}}}xᵢ^{(b)}, is the estimate of safety stock for the b-th bootstrap sample such that Y (b) is the P1-th quantile for the b-th bootstrap sample.

In the absence of guidance on bootstrapping safety stocks in the extant literature, operations managers may intuitively estimate bootstrap safety as SS=Ý*-\hat{μ}\tilde{X} where Ŷ* is the estimate for the ROP at a given P1 service level and ûₓ=û_{L}û_{D} is the empirical estimate of the mean of LTD. As the theory in Section 2.1 shows this would ignore useful information about the covariance structure between the two statistics and incorrectly estimate the variance of the safety stock estimator.

Next, the numerical experiments are presented which investigate the methodological issues raised in the extant theory comparing the bootstrap mixture approach and classic approaches including the commonly used normal and gamma approaches, against true benchmarks. The results of these experiments demonstrate the efficacy of the proposed bootstrap mixture approach relative to comparable extant approaches for estimating safety stocks and minimizing inventory costs under different replenishment conditions represented by standard and non-standard LTD distributions.

### 3. Numerical Experiments

While the research is motivated by the need to estimate safety stocks when common LTD distributional assumptions are invalid (e.g., at MakerCo), two primary considerations influenced the use of a series of targeted numerical experiments. First, using numerical experiments allows for knowing and controlling the true safety stock, which cannot be controlled or known in a practical setting like MakerCo. Second, the numerical experiments expand on the asymptotic results to better understand the finite sample properties of the bootstrap safety stock estimator. Hence, a study was conducted to confirm the correct bootstrap sample size. The results show that m=n_{\tilde{L}} provide the best statistical properties, especially the ability to correctly detect the truth within the resulting confidence intervals. The results further show that if m≥n_{\tilde{L}} the estimated confidence intervals become overly narrow and will not meet the statistical properties guided by Corollary 1. Hence, m=n_{\tilde{L}} is used for the remainder of the numerical experiments. These results also address some of the confusion from Monte-Carlo methods that construct empirical LTD from bootstrap demand using bootstrap samples of size m=B. Nevertheless, an explicit comparison is conducted of the present approach with the Monte-Carlo methods.

These numerical experiments focus on bimodal LTD distributional forms as a proxy for non-standard distributions as all the SKUs encountered in the MakerCo setting exhibit non-standard LTD forms. However, it is likely that other SKUs in the MakerCo and other settings may take on unimodal LTD distributional forms. Therefore, although the conventional approaches are expected to perform better with unimodal LTD, numerical experiments are also performed with unimodal experiments. This allows for both the checking the internal validity of the simulation ensuring a known result and ensuring that if the bootstrap instead of a conventional approach is applied to an unimodal LTD distribution it will ‘do no harm.’ For bimodal lead times, the mixture ratio (π) of the left and right modes is varied to yield left- and right-skew distributions (Table 1). For all experiments, a single gamma demand distribution is employed with a CV=0.2 that allow for the representation of the non-standard LTD distributions using only the skew and bimodality of the lead time distributions.

### 3.1 Safety Stocks

The focus is on comparing the proposed approach with classic approaches widely used in textbooks and ERP systems' inventory calculations. The safety stock levels are calculated assuming complete backordering, comparing the safety stock calculated by the bootstrap, and normal and gamma methods to the optimal safety stock for every experiment level. The quantile estimate Y*(b) of each bootstrap sample (b) is calculated using both the rank quantile estimator and the SV3 estimator for right-tailed quantiles. These two quantiles represent a limited sample of the quantile estimators available and allows for control for the effects of the bootstrap method under different settings.

TABLE 1
Component distributions of the bimodal lead time distributions
used to generate the mixture of lead time demand.

| Mean | CV | Skew | π | μL1 | σL1 | μL2 | σL2 |
|---|---|---|---|---|---|---|---|
| 5 | 0.34 | −1.18 | 0.2 | 1.8 | 0.4 | 5.8 | 0.6 |
| 5 | 0.9 | 1.53 | 0.8 | 2.8 | 0.56 | 13.86 | 1.39 |
| 25 | 0.34 | −1.19 | 0.2 | 9 | 1.8 | 29 | 2.9 |
| 25 | 0.9 | 1.52 | 0.8 | 13.93 | 2.79 | 69.3 | 6.93 |

Note.
Component distribution 1 (with weight π) of the bimodal lead time distribution is gamma with the α and β parameters taken as α = μ2/σ2 and β = σ2/μ, and distribution 2 of the bimodal distribution is normal. Distribution of demand is fixed as a gamma distribution with μD = 100 and CVD = 0.2.

The normal safety stock is estimated as SS^{N}=F_{Z}⁻¹(P₁)·\hat{σ}_{\tilde{X}} and the gamma safety stock is estimated as SS^{N}=F_{Z}⁻¹(P₁)−\hat{μ}_{\tilde{X}}. Where, F_{Z}⁻¹(·) is the inverse CDF of the standard normal distribution and \hat{μ}_{X}=\hat{μ}_{L}·\hat{μ}_{\tilde{D}} is the mean of LTD estimated from lead time. Similarly, F_{τ}⁻¹(·) is the inverse CDF of the Gamma distribution and is the variance of LTD. The mean and variance of LTD are estimated from the estimates of mean and standard deviation of empirical lead time and demand.

It is set that m=n_{\tilde{L}}, B=1,000 and the levels of n_{\tilde{L}}=6, 12, 24, 50, 100. It is set that n_{\tilde{D}}=n_{L}, 2n_{L} as it is reasonable to assume that the sample size of demand will be either as large or larger than the sample size of lead time. P1=60%-99% (40 levels), yielding 2,400 experiments for the unimodal case and 1,600 experiments for the bimodal case. The experiments are run in R version 3.5.2 on a Unix system in a high performance computing cluster with 100 replications using fixed random seeds to ensure reproducibility. Safety stock is calculated using all four methods (normal, gamma, bootstrap with rank quantile, and bootstrap with SV3 quantile) for each replication, which is a combination of a lead-time distribution and a level of nL, nD and P1. It is estimated that the mean absolute deviations (MAD) of each approach's estimate from optimal safety stock across the 100 replications. Statistical tests are then conducted comparing the MAD across the estimation approaches in one-way ANOVAs.

As expected in the unimodal case, it is seen that for almost all experiments reported, setting safety stocks by using the gamma distribution to represent LTD provides the lowest mean absolute percentage error (MAPE). Nevertheless, the MAD for the gamma and normal approaches are rarely lower in a statistically significant way as compared to bootstrap approaches. This establishes that using the bootstrap with unimodal LTD will do no harm.

The results are reported for the bimodal lead-time case in Table 2. While MakerCo managers only care about P1 values that predominantly coincide with the right mode, for completeness, P1 values across both modes are explored, which provides some interesting insights when P1 lies in the trough between the bimodal densities. In order to visually represent settings where each method's estimate is not statistically different from the benchmark, the results are sorted by method and ng. Results are shown for n_{\tilde{D}}=n_{\tilde{L}}. It is shown that the bootstrap approaches outperform normal and gamma approaches except for P1 values between 70%-80%.

TABLE 2
MAPE from optimal safety stocks for bimodal lead time, μL = 25, CVL =
0.34, π = 0.2 with bootstrap approaches using B = 1,000 resamples.
The lowest MAPE value for each experiment is in bold. Cells are shaded if MAD from
optimal safety stock are not statistically significantly different from the method with the lowest MAD.

| Method | nL | 60% | 65% | 70% | 75% | 80% | 85% | 90% | 95% | 99% | Median |
|---|---|---|---|---|---|---|---|---|---|---|---|
| True Safety Stock | | 397.75 | 446.69 | 496.61 | 549.55 | 607.37 | 673.55 | 756.08 | 876.78 | 1099.85 | |
| Boot-Rank | 6 | 39% | 35% | 34% | 35% | 36% | 35% | 34% | 35% | 40% | 35% |
| | 10 | 29% | 30% | 30% | 29% | 28% | 27% | 27% | 27% | 33% | 29% |
| | 24 | 25% | 24% | 23% | 21% | 21% | 20% | 19% | 18% | 22% | 21% |
| | 50 | 19% | 18% | 17% | 16% | 15% | 14% | 13% | 12% | 14% | 15% |
| | 100 | 12% | 11% | 10% | 9% | 9% | 8% | 7% | 7% | 8% | 9% |
| Boot-SV3 | 6 | 77% | 59% | 45% | 36% | 33% | 33% | 34% | 35% | 40% | 36% |
| | 10 | 43% | 31% | 28% | 27% | 27% | 26% | 26% | 27% | 33% | 27% |
| | 24 | 23% | 23% | 22% | 21% | 20% | 19% | 19% | 18% | 22% | 21% |
| | 50 | 19% | 18% | 17% | 16% | 14% | 13% | 13% | 12% | 14% | 14% |
| | 100 | 12% | 11% | 10% | 9% | 9% | 8% | 7% | 7% | 7% | 9% |
| Gamma | 6 | 76% | 53% | 33% | 25% | 34% | 50% | 67% | 91% | 131% | 53% |
| | 10 | 73% | 50% | 31% | 17% | 23% | 36% | 54% | 78% | 117% | 50% |
| | 24 | 71% | 48% | 28% | 12% | 17% | 30% | 47% | 72% | 111% | 47% |
| | 50 | 70% | 48% | 28% | 10% | 12% | 28% | 47% | 73% | 113% | 47% |
| | 100 | 70% | 47% | 27% | 8% | 11% | 28% | 49% | 74% | 115% | 47% |
| Normal | 6 | 48% | 32% | 29% | 34% | 43% | 52% | 62% | 74% | 90% | 48% |
| | 10 | 48% | 30% | 20% | 22% | 28% | 38% | 49% | 62% | 80% | 38% |
| | 24 | 47% | 29% | 15% | 15% | 22% | 31% | 42% | 56% | 75% | 31% |
| | 50 | 47% | 28% | 12% | 10% | 18% | 29% | 42% | 57% | 76% | 29% |
| | 100 | 46% | 27% | 11% | 7% | 17% | 30% | 43% | 58% | 78% | 30% |

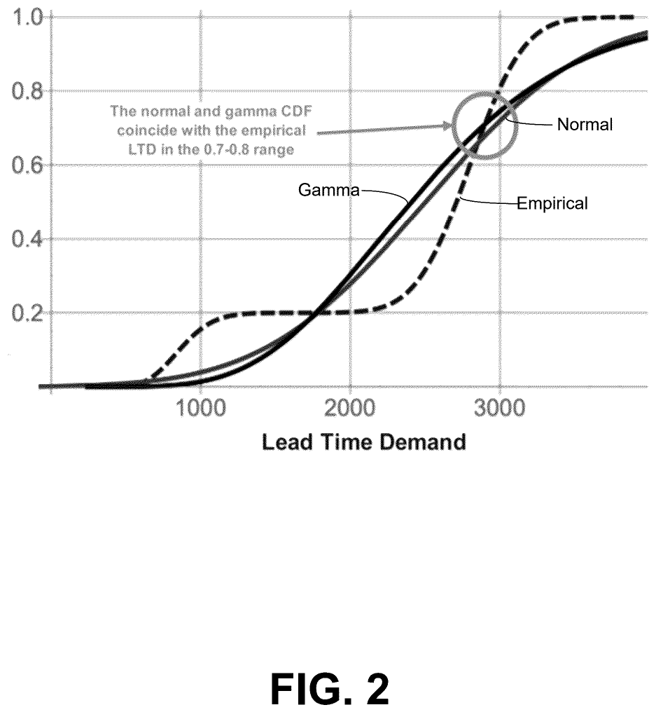

FIG. 2 provides two insights that help to explain this result. Firstly, when LTD are multimodal, for certain values of P1, the ideal safety stock value will specify an ROP that is in-between modes of LTD. Secondly, simultaneously the CDF of the true LTD and parametric distributions used in the classic normal and gamma approaches may intersect at the desired service level yielding least MAD. Operations managers have little a priori knowledge of such serendipitous intersections of the parametric and the true LTD distribution at the desired P1. However, the more important question is the magnitude of increased inventory cost from using the bootstrap approach versus the more accurate parametric approaches when the latter's CDF intersects the true in the trough between the modes of a multi-modal distribution. As will be seen in the next section, the improved safety stock estimate serendipitously obtained with the gamma approach does not translate to improved inventory cost.

### 3.2 Inventory Costs

Using the safety stock values from the experiments in Section 3.1, the expected holding and backorder cost implications of deviations from optimal safety stock values are investigated. For a given choice of P1, the under-stocking cost (cost of a unit backorder) is set to be cu=P1 and the over-stocking cost (cost of carrying one unit of inventory for the time between replenishment cycles) to be co=(1-P1). These costs are thus consistent with P1=cu/(cu+co) being the optimal service level choice.

The bimodal (and unimodal) LTD distributions are carried through from Section 3.1 and cost results for the bimodal (unimodal) case presented in Table 3. The true, underlying LTD distribution is used to evaluate expected holding and backorder cost for the reorder points implied by each calculated safety stock value. This expected cost is then compared to the optimal expected cost.

The accurate bootstrap safety stock estimates in Table 2 are largely mirrored in the lower inventory cost results in Table 3. Note that for the cases where the normal and gamma approaches provided more accurate safety stock estimates (see 0.7≤P1≤0.8 in Table 2), this does not translate to significant cost savings since the cost function is relatively flat between modes. This observation is important as it implies that an inventory manager can use the bootstrap in the presence of multi-modal LTD without worrying about whether or not the desired service level falls between modes.

In addition, to provide an overall picture of the results, the complete set of experimental results is analyzed using classification trees with recursive partitioning methodology to identify when each of the methods yielded the best result.

TABLE 3
MAPE from optimal cost for bimodal lead time, μL = 25, CVL =
0.34, π = 0.2 with bootstrap approaches using B = 1,000
resamples. Cells are shaded if MAD from optimal expected cost are not statistically
significantly different from the method with the lowest MAD.

| Method | nL | 60% | 65% | 70% | 75% | 80% | 85% | 90% | 95% | 99% | Median |
|---|---|---|---|---|---|---|---|---|---|---|---|
| Boot-Rank | 6 | 23% | 24% | 25% | 26% | 28% | 34% | 46% | 85% | 391% | 28% |
| | 10 | 10% | 10% | 11% | 12% | 14% | 16% | 22% | 40% | 198% | 14% |
| | 24 | 3% | 3% | 3% | 4% | 4% | 5% | 6% | 10% | 43% | 4% |
| | 50 | 2% | 2% | 2% | 3% | 3% | 3% | 4% | 5% | 17% | 3% |
| | 100 | 1% | 1% | 1% | 1% | 1% | 2% | 2% | 3% | 7% | 1! |
| Boot-SV3 | 6 | 34% | 34% | 34% | 34% | 36% | 40% | 51% | 88% | 394% | 36% |
| | 10 | 16% | 15% | 14% | 14% | 15% | 17% | 23% | 41% | 199% | 16% |
| | 24 | 3% | 3% | 3% | 4% | 4% | 5% | 6% | 9% | 43% | 4% |
| | 50 | 2% | 2% | 2% | 3% | 3% | 3% | 3% | 5% | 17% | 3% |
| | 100 | 1% | 1% | 1% | 1% | 1% | 2% | 2% | 3% | 6% | 1% |
| Gamma | 6 | 35% | 33% | 31% | 27% | 25% | 26% | 35% | 61% | 116% | 33% |
| | 10 | 26% | 24% | 20% | 16% | 13% | 16% | 26% | 50% | 96% | 24% |
| | 24 | 15% | 11% | 7% | 5% | 6% | 13% | 27% | 52% | 95% | 13% |
| | 50 | 17% | 12% | 8% | 4% | 4% | 10% | 24% | 50% | 94% | 12% |
| | 100 | 15% | 10% | 6% | 2% | 3% | 9% | 25% | 51% | 96% | 10% |
| Normal | 6 | 25% | 24% | 23% | 22% | 23% | 26% | 33% | 47% | 81% | 25% |
| | 10 | 17% | 15% | 13% | 12% | 13% | 16% | 23% | 37% | 62% | 16% |
| | 24 | 8% | 6% | 4% | 5% | 7% | 13% | 23% | 39% | 62% | 8% |
| | 50 | 9% | 6% | 4% | 3% | 5% | 10% | 20% | 36% | 61% | 9% |
| | 100 | 7% | 4% | 2% | 2% | 4% | 10% | 21% | 37% | 62% | 7% |

In particular, it can be seen that the bootstrap as a data-driven method fares best when data are available at the P1 level where safety stock must be calculated, which improves with larger sample size (n_{\tilde{L}}≥24).

Results from these controlled experiments demonstrate that the proposed bootstrap approach is competitive with classic approaches when LTD distributions are unimodal, and can provide improved performance when LTD distributions are multi-modal (Tables 2 and 3), even with moderate levels of data availability. This suggests that the present approach may work well for the multi-modal LTD distributions observed for MakerCo (FIG. 1). The fact that the bootstrap approach provides a marked improvement for multi-modal LTD distributions, and appears to ‘do no harm’ if LTD happens to fit classic unimodal assumptions, is important as the burden to MakerCo (or other) practitioners should not be increased with needing to pick and choose when to bootstrap and when to use traditional methods. These insights provided the MakerCo operations management team with confidence to move to the next step in the implementation process: working with the procurement planning team to procure the organizational data necessary to rigorously test the proposed bootstrap approach for their own raw materials replenishment inventories in a discrete-event simulation. In the next section, this simulation study and its results that eventually led the MakerCo management team to run a pilot implementation are described. Results from the pilot implementation are also described in the next section.

### 4. Industry Application

MakerCo's nonstandard distributions of LTD yielded safety stock estimates that failed to meet the desired service levels and inventory budget. This is because the classic methods built into MakerCo's, and most ERP systems require standard distributional assumptions. Hence, MakerCo's management resorted to alternate, elaborate yet imprecise solutions that were sub-optimal (e.g., maximized customer service at the expense of holding cost). To determine the applicability of the approach in a practical setting, it was sought to validate the bootstrap beyond the known distributional settings studied in Section 4. To do this, the firm's raw materials' replenishment operation were simulated. MakerCo operates a continuous review (s, Q) inventory policy with order quantities (Q) determined by minimum-order-quantities set by the supplier or the frequency of MakerCo's production needs. MakerCo management aimed for a service level of P1=95%. Using the baseline approach, safety stocks are manually calculated in a spreadsheet each quarter and entered into the inventory module of the ERP system that would use the fixed, preset supplier lead times to set the ROP. Raw material replenishment decisions are made continuously to maintain sufficient safety stocks depending upon the production usage. In case of stockouts any unmet demand due to production shortfalls is backordered.

### 4.1 Simulation Model

The team worked with MakerCo to collect data for 9 raw material SKUs. Lead time data were collected from each SKU's ordering history. For the demand data, the parent finished good's historic demand was used as there is a one-to-one relationship between finished goods and the raw materials in this study. As the lead time and demand did not conform to any standard distributional forms, empirical histograms were employed for each of these inputs to the simulation. Baseline safety stocks along with the resulting reorder points were used from the firm's operations. For each SKU a benchmark LTD distribution was compiled from the empirical lead time and empirical demand data using a Monte-Carlo simulation with one million draws. From these “true” benchmark LTD distributions, the benchmark safety stock was computed for the desired P1=95% and other LTD statistics for each SKU, which were used to check the internal logic of the simulation model as well as used for later comparisons.

Each simulated day observed demand is fulfilled from available inventory, the unfilled portion of demand is backordered. A replenishment order of fixed quantity Q is placed when the inventory position (on-hand inventory and orders outstanding) is less than or equal to the ROP. At the end of each simulated day inventory and order records are updated.

Three identical discrete-event simulations of the firm's daily inbound raw material replenishment inventory management process run in parallel. One simulation replicated MakerCo's extant inventory operations (baseline), a second simulated the use of the bootstrap approach to set inventory policies (bootstrap), and the third used the gamma approach to set inventory policies (gamma). A limited experimental frame was set using three levels each of n_{\tilde{L}}=6, 10, 24 and n_{\tilde{D}}=6, 10, 24 corresponding to the data availability defined by the firms' operations managers. Each experiment ran for 20 replications yielding a total of 320 runs for each method and SKU combination. The baseline, bootstrap or gamma inputs are calculated after the warmup period employing the historic n_{\tilde{L}} and n_{\tilde{D}} values collected by the end of the warm-up period. The inventory policies by each approach are updated every 30 days reflecting MakerCo's practice. A common random vector of daily demand is used by all three simulations running in parallel. An order is triggered separately by each of the three simulations for which a lead time value is randomly drawn from the lead time distribution of the SKU for which the inventory process is being simulated. Thereby, the difference in safety stocks, realized P1 and total inventory costs (holding and backorder) is only due to the inventory estimates used and comparable across the three approaches.

### 4.1.1 Model Validation

Accurate LTD data is an outcome of the correct functioning of the simulation and is critical for correctly setting the inventory policies therein. The LTD statistics simulation output can be compared with that of the benchmark LTD distribution statistics run independently in the Monte-Carlo simulation. T-tests were used to compare the simulated LTD mean and standard deviation from the three methods for each SKU with the benchmark LTD mean and standard deviation. The comparisons use t-test confidence intervals for the mean deviation (MD) of each simulated LTD statistic from the benchmark value shown in the e-companion Appendix EC.6 Table EC.9. The results confirm that in virtually all cases the simulated data are not significantly different from the benchmark. An exception is for average LTD for SKU 16, which is still close to the benchmark.

To ensure the simulation was satisfactorily modeling MakerCo's process for managing inbound raw material replenishment inventories, the research team met several times with the management team and provided graphical output of the simulated inventory system for each SKU, represented by the inventory balance on hand, inventory position and backorders. The graphs of the simulated inventory system allowed the management team to identify the symptoms they encountered particularly with SKUs that posed a management challenge.

### 4.2 MakerCo Simulation Results

The results of the 320 runs were used to conduct one way ANOVAs for each SKU, one for each n_{\tilde{L}} and n_{\tilde{D}} combination. The MAD of each method's safety stock estimator from that of the benchmark was used as the response variable and the method as the predictor. For each ANOVA, multiple pairwise comparisons were conducted of each method's MAD by constructing confidence intervals using the Bonferroni correction for multiple t-test comparisons. The results of these analyses are compiled in Table 4 where the MAD of each method's average safety stock from the benchmark is shown as a percentage of the true safety stock for each n_{\tilde{L}} and n_{\tilde{D}} combination. For each experiment, the cell is colored where the difference of that cell's MAD from the lowest MAD is not statistically significant at the α=0.05 level. In order to visually represent settings where each method's estimate is not statistically different from the benchmark, the results are sorted by method, n_{\tilde{L}} and n_{\tilde{D}}.

TABLE 4
Results of the 9 one-way ANOVAs for each of the 9 SKUs comparing the estimators of the bootstrap,
gamma and baseline as the MAPE from the benchmark. (Lowest MAD for each experiment in bold. Cell
is colored if MAD is lowest or if MAD is not statistically significantly different than lowest.)

| | | | | | | | | | | | | Avg % |
|---|---|---|---|---|---|---|---|---|---|---|---|---|
| Method | nL | nD | SKU3% | SKU6 | SKU7 | SKU9 | SKU10 | SKU13 | SKU14 | SKU16 | SKU17 | age Diff |
| Bootstrap | 6 | 6 | 33% | 28% | 42% | 26% | 15% | 26% | 44% | 47% | 43% | 34% |
| | | 10 | 32% | 30% | 47% | 15% | 18% | 32% | 44% | 51% | 50% | 35% |
| | | 24 | 37% | 31% | 49% | 20% | 19% | 40% | 50% | 49% | 54% | 39% |
| | 10 | 6 | 9% | 11% | 23% | 40% | 18% | 7% | 22% | 22% | 18% | 19% |
| | | 10 | 11% | 13% | 27% | 25% | 13% | 10% | 24% | 26% | 25% | 19% |
| | | 24 | 14% | 14% | 26% | 14% | 12% | 17% | 24% | 25% | 32% | 20% |
| | 24 | 6 | 9% | 11% | 11% | 62% | 41% | 19% | 10% | 8% | 16% | 21% |
| | | 10 | 8% | 9% | 8% | 41% | 22% | 11% | 10% | 9% | 7% | 14% |
| | | 24 | 4% | 10% | 7% | 19% | 20% | 5% | 11% | 10% | 4% | 10% |
| Gamma | 6 | 6 | 31% | 16% | 9% | 91% | 51% | 26% | 14% | 13% | 13% | 29% |
| | | 10 | 29% | 14% | 13% | 74% | 40% | 14% | 12% | 10% | 14% | 25% |
| | | 24 | 21% | 11% | 14% | 43% | 31% | 9% | 16% | 13% | 20% | 20% |
| | 10 | 6 | 37% | 18% | 8% | 84% | 58% | 35% | 13% | 7% | 6% | 30% |
| | | 10 | 35% | 18% | 6% | 71% | 41% | 23% | 12% | 8% | 10% | 25% |
| | | 24 | 30% | 15% | 7% | 54% | 30% | 14% | 13% | 6% | 17% | 21% |
| | 24 | 6 | 42% | 21% | 6% | 88% | 61% | 44% | 15% | 8% | 12% | 33% |
| | | 10 | 41% | 19% | 6% | 72% | 37% | 31% | 13% | 7% | 6% | 26% |
| | | 24 | 35% | 18% | 5% | 48% | 35% | 23% | 14% | 8% | 7% | 21% |
| Baseline | 6 | 6 | 125% | 67% | 67% | 204% | 15% | 73% | 35% | 8% | 84% | 75% |
| | | 10 | 124% | 65% | 68% | 205% | 15% | 75% | 37% | 9% | 85% | 76% |
| | | 24 | 124% | 65% | 66% | 204% | 18% | 74% | 34% | 8% | 83% | 75% |
| | 10 | 6 | 123% | 67% | 69% | 206% | 18% | 75% | 33% | 7% | 84% | 76% |
| | | 10 | 125% | 64% | 69% | 203% | 16% | 77% | 35% | 9% | 83% | 76% |
| | | 24 | 125% | 64% | 66% | 203% | 15% | 71% | 37% | 9% | 84% | 75% |
| | 24 | 6 | 126% | 66% | 69% | 204% | 19% | 73% | 30% | 8% | 83% | 75% |
| | | 10 | 123% | 65% | 66% | 202% | 18% | 74% | 32% | 8% | 84% | 75% |
| | | 24 | 123% | 64% | 66% | 203% | 16% | 74% | 31% | 8% | 84% | 74% |

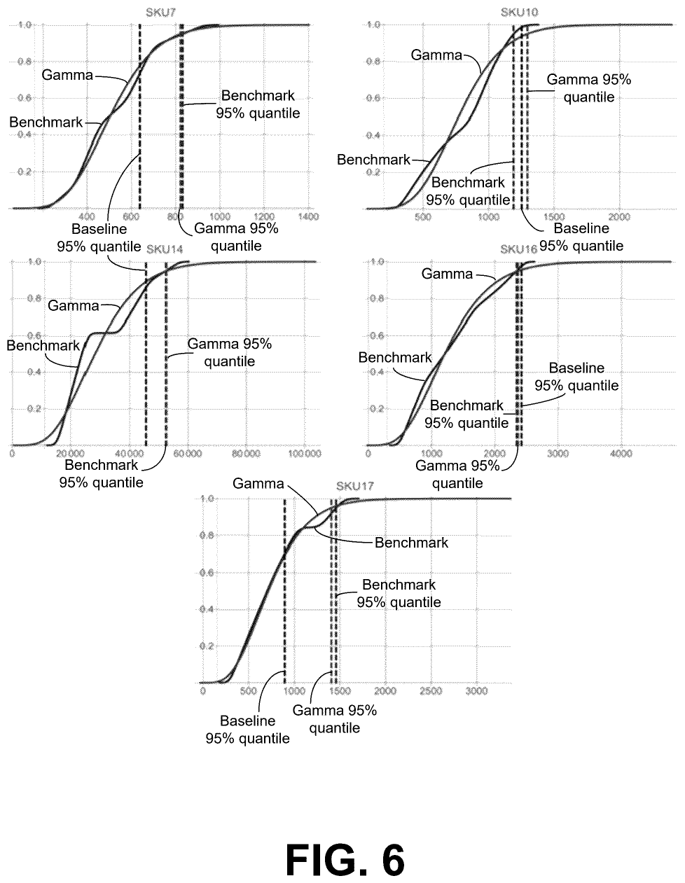

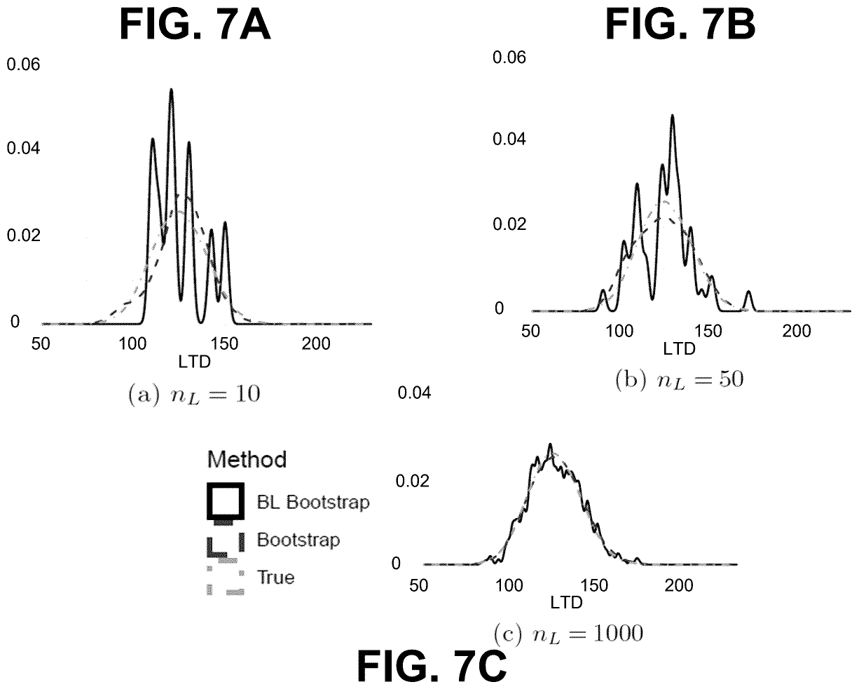

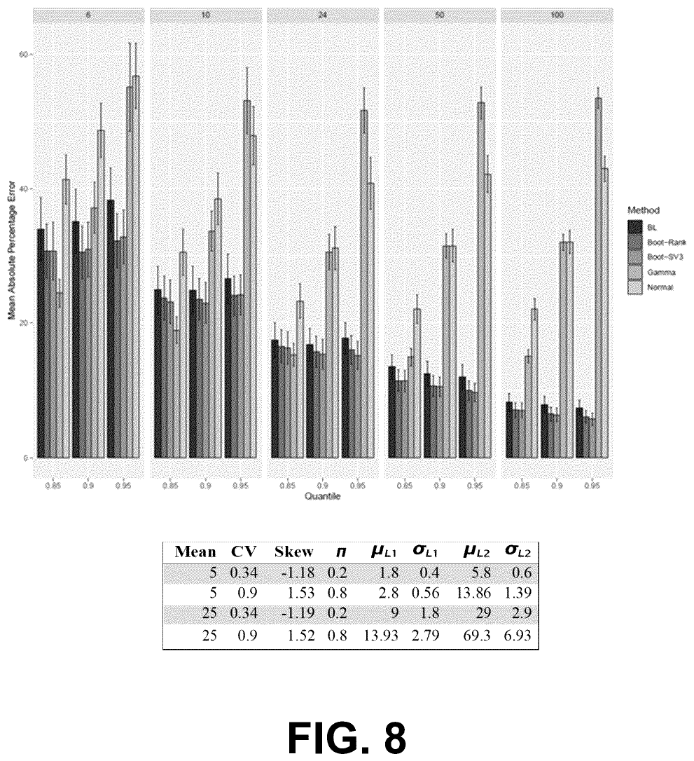

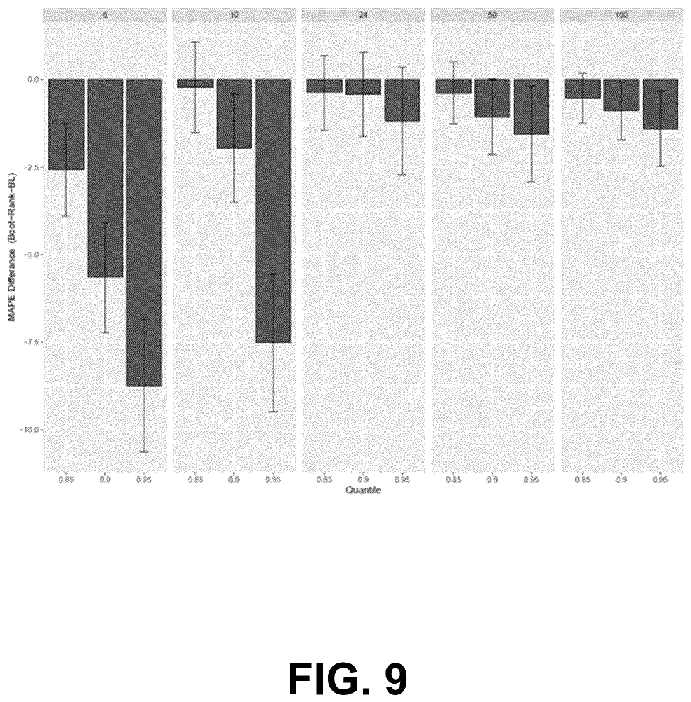

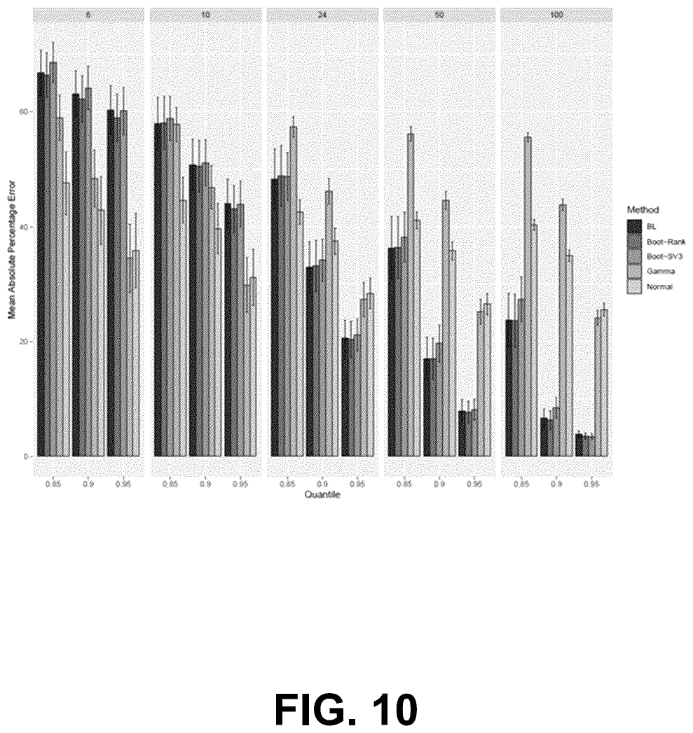

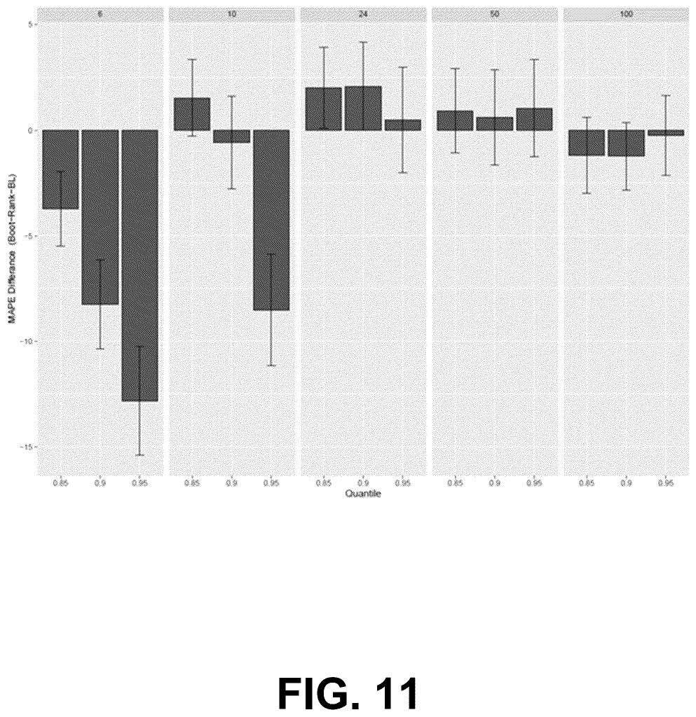

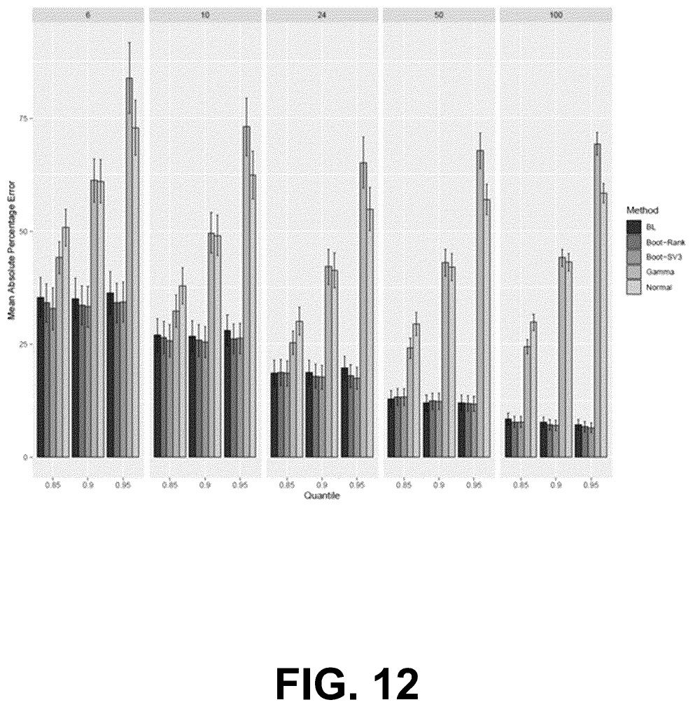

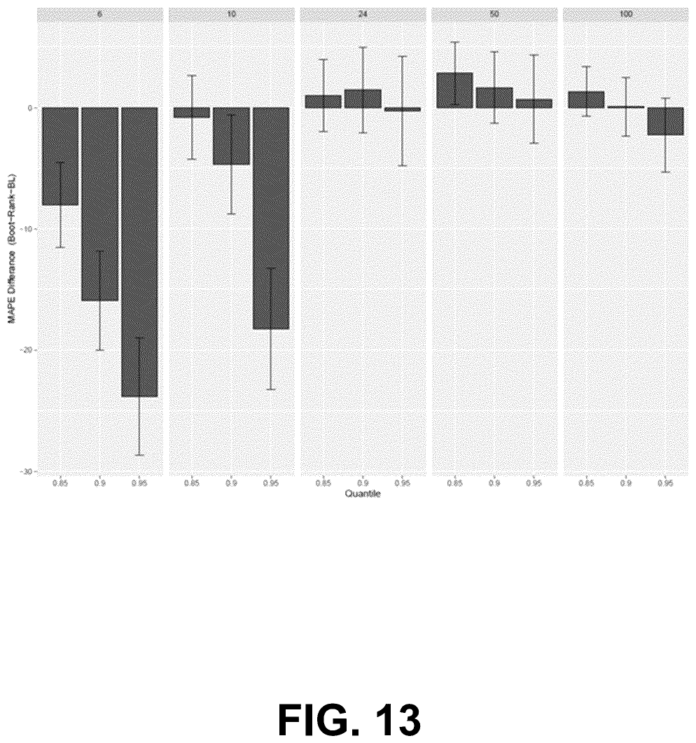

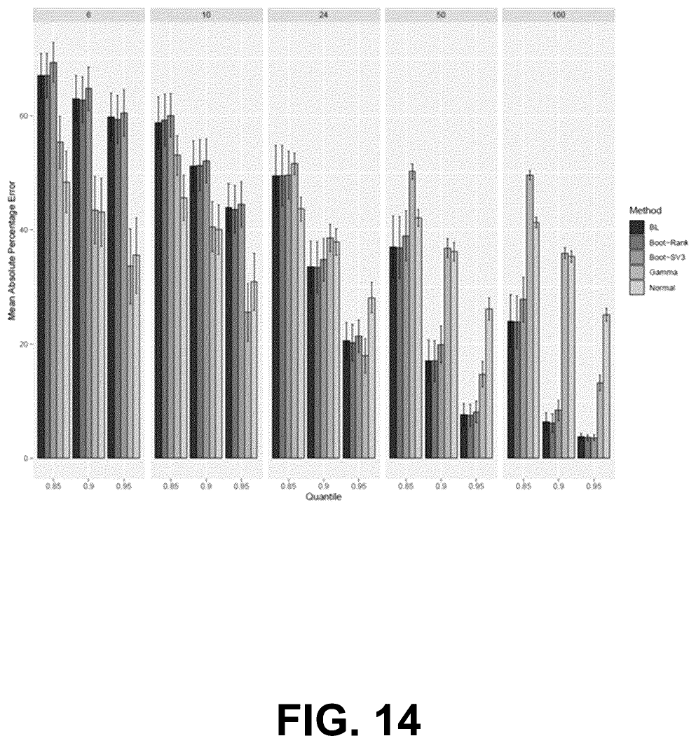

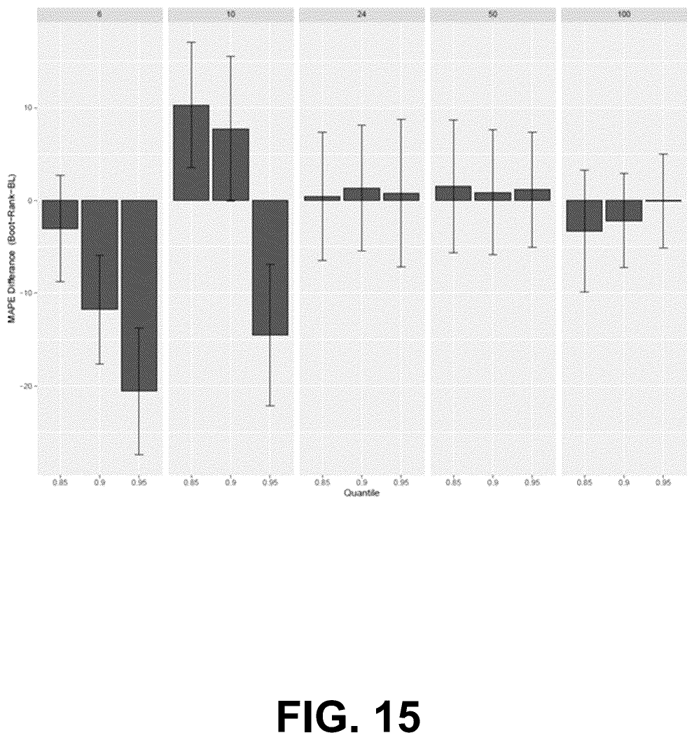

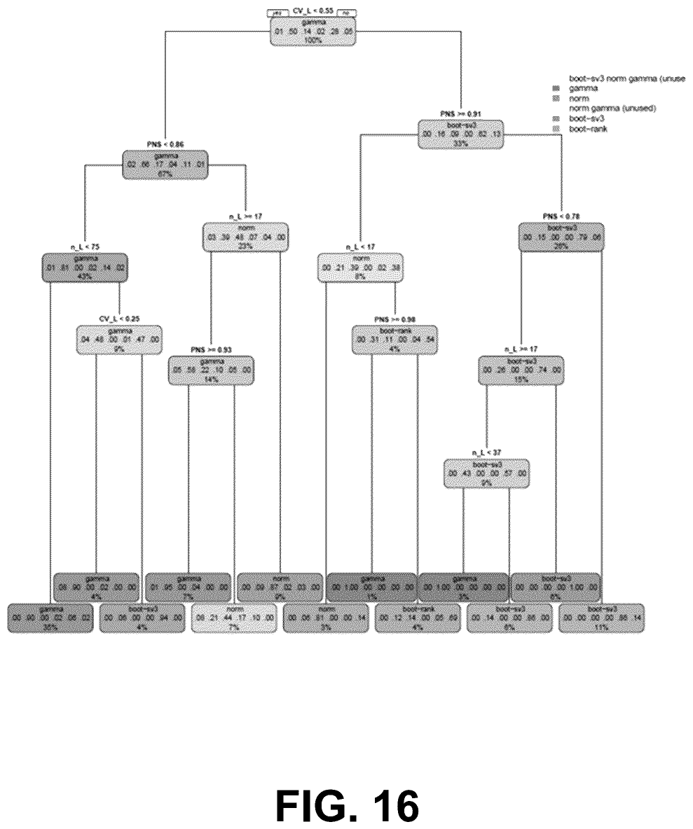

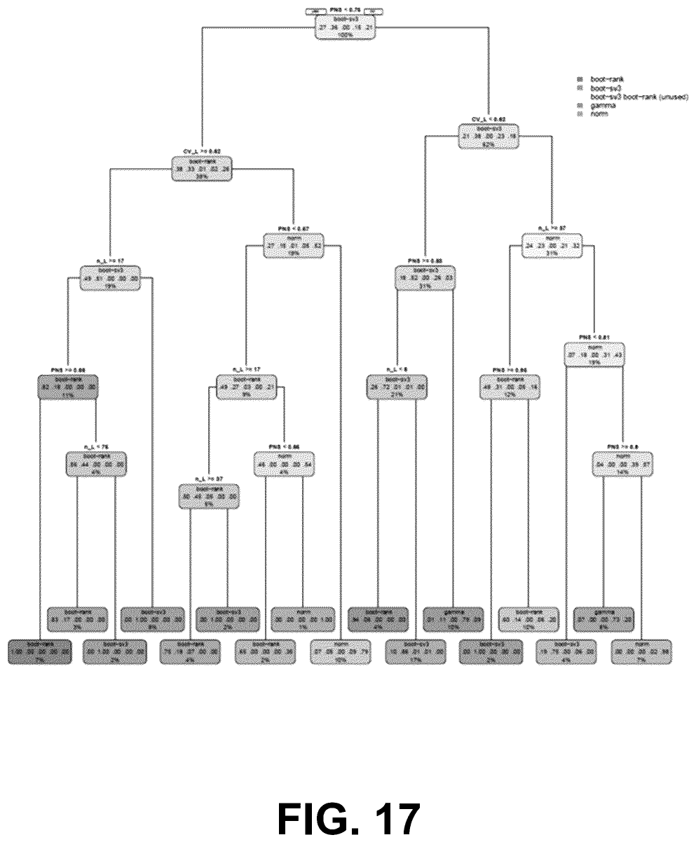

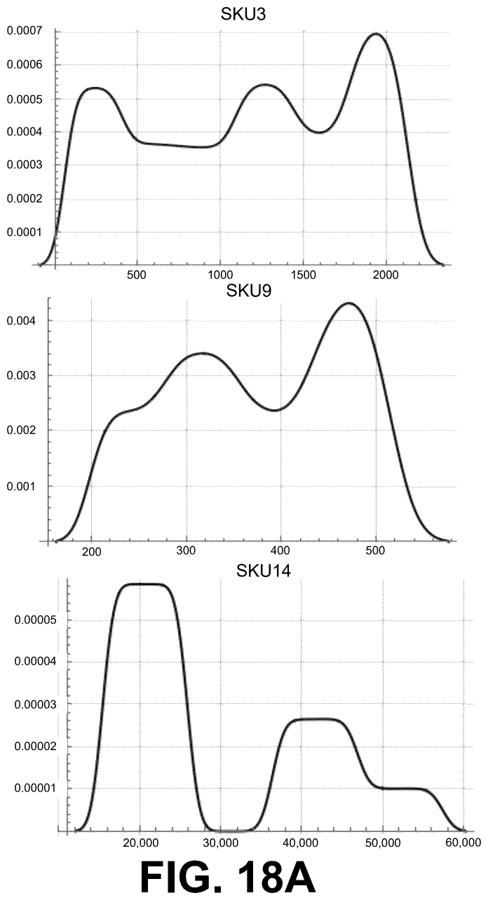

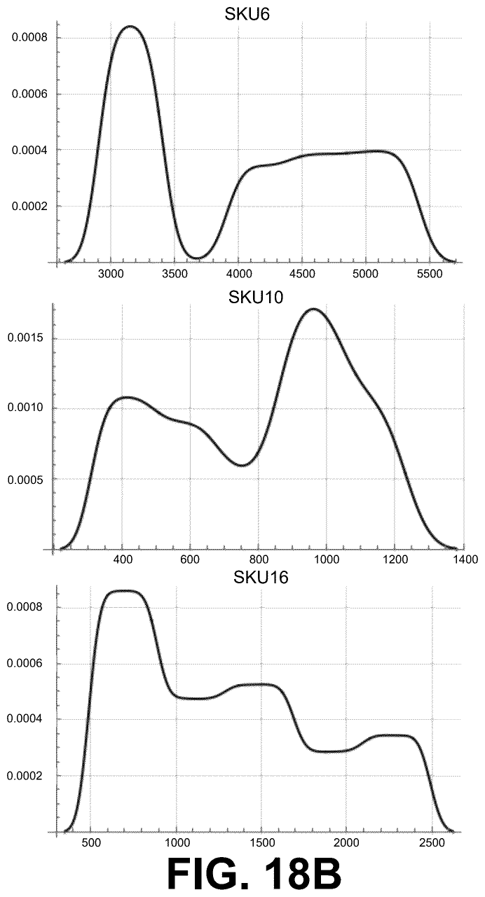

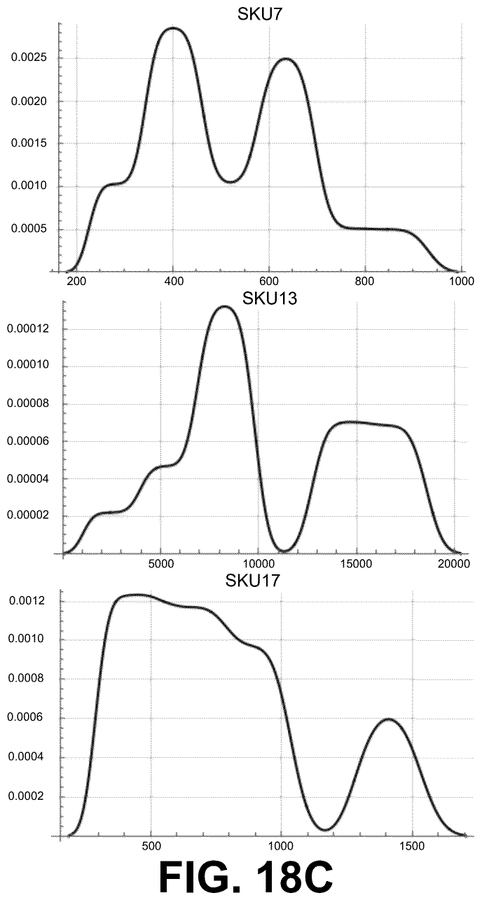

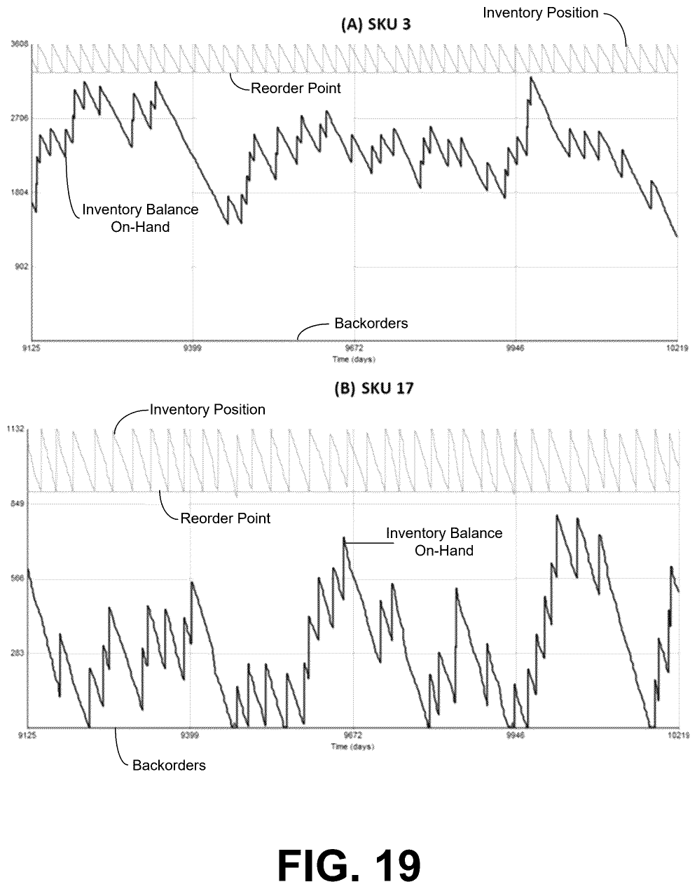

For each Method, n_{\tilde{L}} and n_{\tilde{D}} combination, the MAPE of the estimate is averaged from the benchmark across all SKUs, in the last column of Table 4. In the last column, data-bars representing the percentages in each cell are used to provide a visual of the settings where the methods' estimates are closest to the benchmark. From this column it is apparent that the difference of the bootstrap safety stock estimator from the benchmark safety stock becomes smaller as a function of n_{\tilde{L}} and to a lesser extent ng. From the MakerCo and the controlled simulations, it can be concluded that the bootstrap is almost always the best method when n_{\tilde{L}}≥24. Notably, for some SKU's the baseline and the gamma appear to yield the safety stocks closest to the benchmark. The baseline, representing MakerCo's current method, provides the estimate closest to the benchmark for SKUs 10 and 16; and, the gamma does the same for SKUs 7, 14, 16 and 17. As discussed in Section 3.2, FIG. 2 this is due to the serendipitous coincidence of the baseline and gamma quantiles with that of the benchmark P1=95% for those SKUs. The CDF of the benchmark and the gamma LTD distribution calculated from the benchmark LTD statistics were plotted and overlayed by the gamma, MakerCo's baseline and benchmark reorder points on the plots for each SKU (FIG. 6). The baseline approach provides an estimate of 440 and 1, 120 that due to chance is close to P1=95% benchmark of 456 and 1,039 for SKUs 10 and 16, respectively. Similarly, the serendipitous coincidence of the gamma and benchmark quantile at the P1=95% for SKUs 7, 14, 16 and 17 result in gamma estimates that are closer to the benchmark.

### 4.2.1 Cost Results

For the purpose of illustration here, per-unit holding and backorder costs from the specified service level are inferred. For a given choice of P1, the underage cost cu was implied as (P1·h·v·Q/D)/(1-P1). Therefore, the coverage cost co can be taken as the product of the SKU value v, holding cost h, and length of the order cycle Q/D. MakerCo's values were taken for each SKU's P1=95% holding cost h=18%, order quantity Q, annual average demand D, and unit cost v. Q and D are provided for each SKU, the values v of each SKU are withheld.

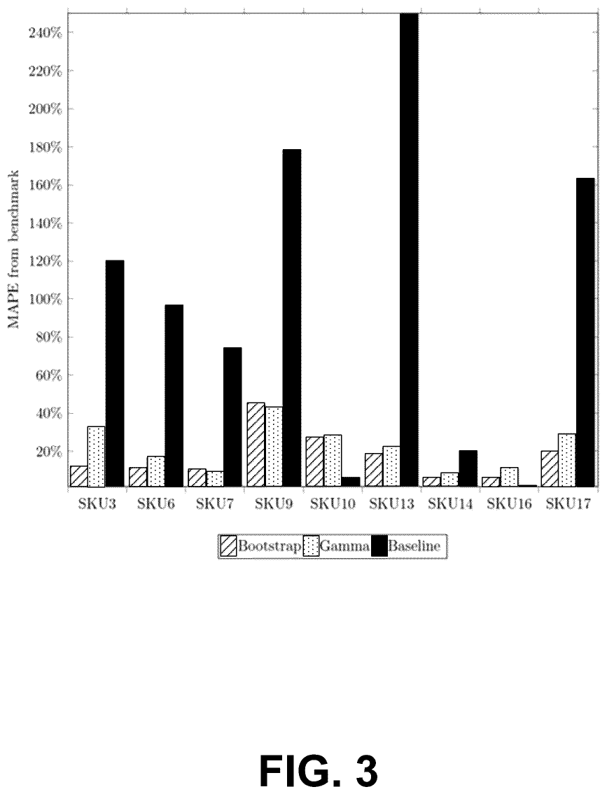

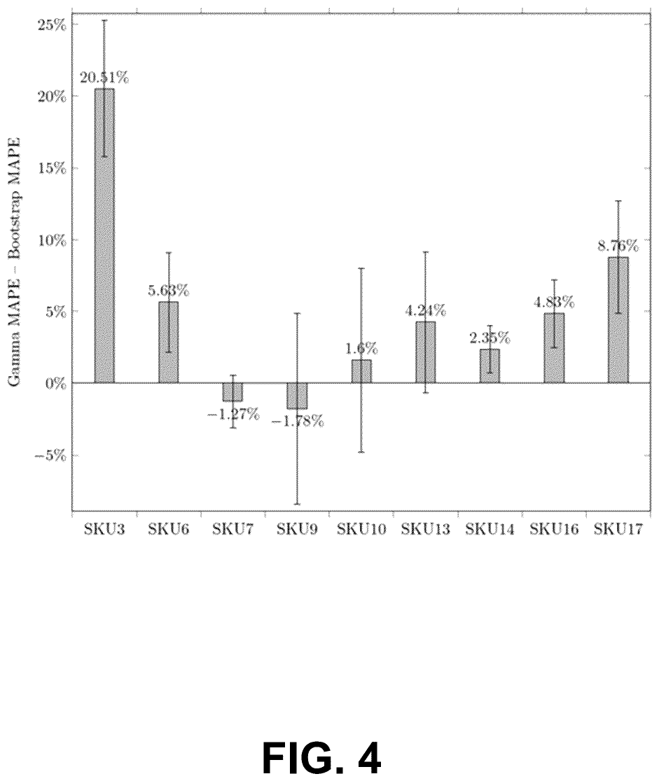

For each of the 9 SKUs, 100 replications of a Monte-Carlo simulation were conducted at P1=95% for n_{\tilde{L}}=n_{\tilde{D}}=24, which typified MakerCo's sample size of lead time and demand. Each replication consisted of a random draw of n_{\tilde{L}}=24 lead times and n_{\tilde{D}}=24 demands from the empirical distributions constructed from MakerCo's lead time and demand data. These random draws of lead time and demand are used to estimate the gamma, baseline and the bootstrap reorder points. The resulting reorder points are used to estimate the safety stock and expected shortage in each cycle. The benchmark LTD distributions provided the benchmark safety stock, shortages and total cycle costs for comparison. The results of the comparison of the three approaches to the benchmark is reported in FIG. 3 as a MAPE of each method from the benchmark. The bootstrap and gamma estimates result in significantly lower costs to that of the baseline, exhibiting the potential for several orders of magnitude of cost savings from employing these approaches over the baseline. As expected from the results in Table 4 the baseline is better than the bootstrap and gamma for SKUs 10 and 16; this is due to chance. It should be noted that the difference of the baseline from the bootstrap and gamma for SKU's 10 and 16 are not statistically significant. In order to determine the relative cost performance of the bootstrap and the gamma, the MAPE of the bootstrap and the gamma from the benchmark were used. Then, the difference between the bootstrap MAPE and the gamma MAPE was taken (FIG. 4). This metric indicates the closeness of the bootstrap to the benchmark relative to the gamma—positive values indicate the average percentage by which the bootstrap is closer to the benchmark than the gamma.

For SKU 3, employing the bootstrap estimate shows the potential of realizing an over 20% cost saving as compared to the gamma. More modest savings are potentially available relative to the gamma for SKUs 6, 14, 16 and 17. These savings are notable as for SKU's 14, 16 and 17 the gamma 95% quantile is very close to the benchmark and for SKU 16 the baseline reorder point coincides with the benchmark quantile (FIG. 6).

### 4.3 Pilot Implementation

For the seven SKUs included in the pilot, a phased implementation was began before the pilot. From August 2017 to September 2018 the procurement planning team at MakerCo implemented a parallel planning system that used the bootstrap approach to estimate safety stocks. Actual requirements were entered into the parallel planning system over time. The resulting overages and underages from using the bootstrap in the parallel system were recorded and compared to the actual realized overages and underages that were a result of the using the baseline approach. The results from the relative performance of the bootstrap in the parallel system over the actuals from using the baseline approach convinced MakerCo managers to implement a pilot using the bootstrap estimates of safety stock beginning in October 2018 until December 2019. During this time the baseline approach was used in the parallel system, which was compared to the actuals obtained under the bootstrap regime. The seven SKUs included in the pilot experienced a total of 67 order-cycles pre-pilot under the baseline regime, six of which experienced a stockout. The pre-pilot service level averaged across all seven SKUs is P1=86.4%. Post-pilot, the seven SKUs experienced 36 order-cycles with only three order-cycles experiencing a stockout. The post-pilot service level averaged across all seven SKUs is P1=89.5%, which is closer to MakerCo's target of 95%. Examining each of the post-implementation stockouts when the bootstrap was employed, it can be seen that two out of the three order cycles would have experienced a stockout had the baseline approach been used to set safety stocks. MakerCo realized an estimated $1.17 million inventory investment reduction from the net reduction in safety stocks across all seven SKUs included in the pilot implementation. The savings is calculated from the difference between the actual overages and underages realized by the pilot implementation of the bootstrap and that realized in the parallel planning system from using MakerCo's baseline approach. This reduction was realized with an overall increase in customer service as measured by the realized P1.

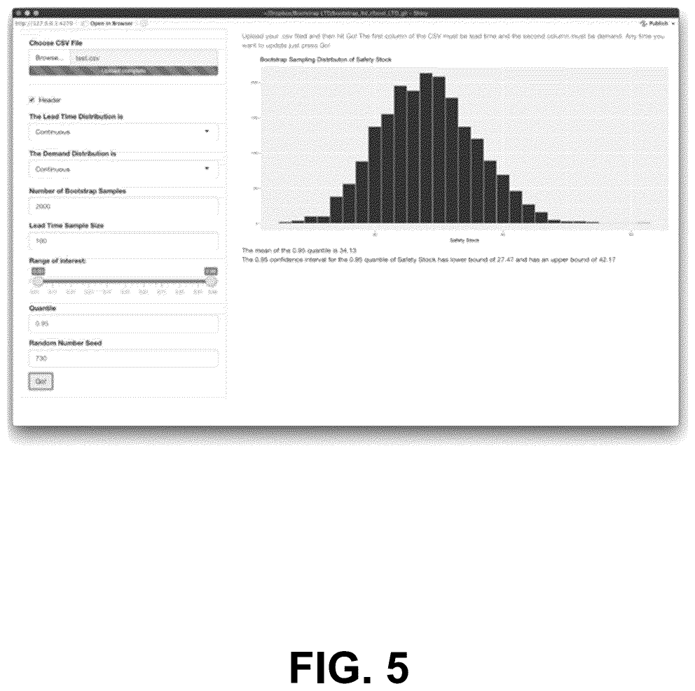

The success of the pilot implementation resulted in MakerCo requesting that the bootstrap approach for calculating safety stocks be rolled out to all replenishment items at the pilot plant. Consequently, the research team developed an online application on a university-operated Shiny server hosted by AWS (FIG. 5), which enables MakerCo material planners to bootstrap the safety stock estimates for quarterly planning and periodic updates of safety stock levels.

In addition to providing a point estimate of safety stocks, the bootstrap approach allows for providing managers with a (1-ß) 100% confidence interval of the bootstrap safety stock estimate (FIG. 5). The upper confidence limit (UCL) and lower confidence limit (LCL) are the

$$1 - \frac{β}{2} and \frac{β}{2}$$

sample quantiles of SS(1), . . . , SS(B) respectively. Intervals could also be constructed using the normality results presented in Section 2.1. Confidence intervals such as these provide additional information that enables managers to adjust safety stock settings based on their experience and the variability of the estimate. For example, for a SKU in the pilot with a bootstrap safety stock estimate of 42.52 units, the 95% confidence interval is [−56.42, 141.46]. It was explained to the managers that this result is due to the variance in the lead-time and demand data, and the confidence interval indicates that a stockout greater than 56.42 units about 2.5% of the time would be expected. The managers then made a decision based upon their knowledge of the business environment, MakerCo's goals and the trade-off between the additional inventory investment and the consequences of stocking out to adjust the safety stock upwards to further reduce the risk of a stockout.

### 5. Discussion and Conclusions

At MakerCo, a situation was encountered where LTD distributions were multi-modal and skewed, and the baseline approach in use led to less than desirable results. To address this problem, a non-parametric, data-driven approach to setting safety stock levels was developed and implemented. In this section, the contributions both to the academic literature and to practice are summarized. Also noted are limitations of this study and opportunities for future research.

The contribution is the development of a bootstrap safety stock estimator based on the compound LTD distribution framework shown to work well in practice. The central limit theorem of the joint asymptotic structure of the bootstrap sample mean and bootstrap sample quantile in Section 2.1 guides the estimation approach to account for covariance between the mean and quantile and enables the construction of statistically sound confidence intervals. The provision of confidence intervals enabled MakerCo's managers to make better informed decisions using the additional information from the variance of the safety stock estimate (FIG. 5). The extant inventory literature does not offer confidence intervals for safety stocks. The bootstrap approach is well suited to do this as it attempts to develop a sampling distribution of the safety stock estimate, under the assumption that lead time and demand are independent-similar to the construction of a two-sided null hypothesis of the statistic of interest in bootstrap hypothesis testing.

In addition to theoretical grounding, the study provides the following practical implementation guidance. Even if paired lead time and demand data are available (which they were not at MakerCo), the unpaired approach is more efficient than the paired LTD approach of Bookbinder and Lordahl (1989), especially in small sample sizes. In addition, evidence is provided underpinning the guidance that m=n_{\tilde{L}} based on extensive experimentation, which should also allay any confusion arising from Monte Carlo methods that some analysts may erroneously set m=B.

While it is not possible to exhaustively test all situations, the extensive numerical experiments herein across a wide range of target service levels and LTD distributions, along with a successful implementation at MakerCo, provide substantial evidence that the bootstrap is an attractive alternative when assumptions in classic approaches are violated. For a firm such as MakerCo achieving poor results with classic approaches, guidance is summarized as follows:

Bootstrap safety stock directly from empirical lead time and demand data. This approach accounts for the covariance between the mean and the quantile (Corollary 1) permitting variance estimation for constructing confidence intervals (FIG. 5).

Use unpaired empirical lead time and demand data instead of pairing lead time with demand data to construct LTD data, even if paired data are available.

Use m=n_{\tilde{L}}.

Expect reliable results when there is sufficient data. In the numerical experiments n_{\tilde{L}}≥24 was sufficient to provide very good bootstrap estimates.

Even if (a) LTD follows a standard unimodal distribution (Tables 6 and 7), or (b) LTD is multi-modal but the target service level falls in a trough between modes (P=75%-80% in Tables 2 and 3), the bootstrap approach still delivers cost results that are competitive or superior to the classic methods.

This last point was important at MakerCo, and is suspected to be important elsewhere, as it was impractical to require managers to pick and choose different approaches for setting safety stocks for different items. While the effectiveness of the bootstrap has been demonstrated in a wide range of settings, the following points of caution are highlighted:
1. If the assumptions of the standard approaches hold across all items in a portfolio the use of readily available standard approaches would deliver the desired results.
2. If available data is very limited the performance of the approach, as well as any other data-driven approach, will be unpredictable.
3. A very high desired service level exacerbates the effect of limited data (e.g., P1=99% and n_{\tilde{L}}≤24 in Tables 3 and 7).

A limitation of this research is the inability to exercise any experimental control in the application of the bootstrap approach in a working production setting. Consequently, as is typically the case when working with an industry partner, this study was constrained to the operational realities of MakerCo's production operations including occasional management overrides of safety stock decisions. Still, the pilot implementation led to sufficient improvement that MakerCo rolled out the approach to encompass more raw materials at more sites.

The numerical experiments provide some generalizability to demonstrate the efficacy of the bootstrap in other settings with non-standard LTD distributions. Given the target SKUs for the pilot implementation, the experiments focus only on fastmoving non-discrete demand items. Future research can resolve the question about the applicability of the bootstrap to manage inventories for discrete-demand and slow-moving items. In the current research, the bootstrap approach is presented for estimating safety stocks for a given P1 under the (s, Q) continuous review policy at MakerCo. Future research can investigate the extension of the bootstrap to the periodic review policy with R review periods by sampling on R+\tilde{L} instead of \tilde{L}. Further inventory policy extensions include the min-max policy, and the fill-rate customer service criterion. Future research can also investigate extending this framework to more complex settings such as cases where a single raw material goes into multiple finished goods. This can be especially challenging in complex bills-of-materials settings when demand for finished goods with common raw materials or components are correlated. Such settings involving complex covariance frameworks include settings when lead-time and demand are correlated, and when demand is correlated across multiple locations for virtual inventory pooling or when making inventory centralization decisions.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A system, comprising:
at least one computing device; and
at least one application executable in the at least one computing device, wherein when executed the at least one application causes the at least one computing device to at least:
receive at least a first input dataset associated with at least a lead time of a first raw material;
receive at least a second input dataset associated with a demand for a plurality of final products, the plurality of final products corresponding to the first raw material;
perform a non-parametric bootstrap using at least the first input dataset and at least the second input dataset to generate a probability density function of lead time demand for the first raw material; and
determine a safety stock estimate for the first raw material based at least in part on the probability density function of lead time demand.

2. The system of claim 1, wherein, when executed, the at least one application further causes the at least one computing device to at least:
receive a third input dataset relating the first raw material to a consumption rate of the plurality of final products; and
the non-parametric bootstrap is performed using at least the first input dataset, at least the second input dataset, and the third input dataset to generate the probability density function of lead time demand for the first raw material.

3. The system of claim 2, wherein, when executed, the at least one application further causes the at least one computing device to at least:
generate a user interface comprising an upload-data component and a set cycle service level component, the upload-data component configured to, upon selection, receive a plurality of input datasets, and the set cycle service level component configured to receive a cycle service level input corresponding to the raw material; and
cause the user interface to be rendered on a client device.

4. The system of claim 3, wherein, when executed, the at least one application further causes the at least one computing device to at least:
generate a results report comprising at least the safety stock estimate and a corresponding confidence interval; and
modify the user interface to include the results report.

5. The system of claim 1, wherein the plurality of input datasets are included in a structured output file.

6. The system of claim 4, wherein the results report are included in a structured output file.

7. The system of claim 1, wherein the first input dataset comprises stochastic replenishment lead-time data for the first raw material.

8. The system of claim 1, wherein the second input dataset comprises stochastic demand data for the plurality of final products.

9. The system of claim 4, wherein, when executed, the at least one application further causes the at least one computing device to at least:
receive diagnostic files, diagnostic files relating to data quality issues in the plurality of input datasets; and
cause the data quality issues to be included in the results report.

10. A method, comprising:
receiving, via at least one computing device, at least a first input dataset associated with a lead time of a first raw material;
receiving, via the at least one computing device, at least a second input dataset associated with a demand for a plurality of final products, the plurality of final products corresponding to the first raw material;
performing, via the at least one computing device, a non-parametric bootstrap using at least the first input dataset and at least the second input dataset to generate a probability density function of lead time demand for the first raw material; and
determining, via the at least one computing device, a safety stock estimate for the first raw material based at least in part on the probability density function of lead time demand.

11. The method of claim 10, further comprising:
receiving a third input dataset relating the first raw material to a consumption rate of the plurality of final products; and
performing a non-parametric bootstrap using at least the first input dataset, at least the second input dataset, and the third input dataset to generate the probability density function of lead time demand for the first raw material.

12. The method of claim 10, further comprising:
generating a user interface comprising an upload-data component and a set cycle service level component, the upload-data component configured to, upon selection, receive a plurality of input datasets, and the set cycle service level component configured to receive a cycle service level input corresponding to the raw material; and
causing the user interface to be rendered on a client device.

13. The method of claim 12, further comprising:
generating a results report comprising at least the safety stock estimate and a corresponding confidence interval; and
modifying the user interface to include the results report.

14. The method of claim 10, wherein the plurality of input datasets comprise comma separated value files.

15. The method of claim 13, wherein the results report comprises a comma separated value file.

16. The method of claim 10, wherein the first input dataset comprises stochastic replenishment lead-time data for the first raw material.

17. The method of claim 10, wherein the second input dataset comprises stochastic demand data for the plurality of final products.

18. The method of claim 13, further comprising:
receiving diagnostic files, diagnostic files relating to data quality issues in the plurality of input datasets; and
causing the data quality issues to be included in the results report.
